(19) United States
(12) Patent Application Publication
(10) Pub. No.: US 2013/0294755 A1
(43) Pub. Date: Nov. 7, 2013

(54) SYSTEMS AND METHODS FOR PREVENTING ACCESS TO A MEDIA ASSET SEGMENT DURING A FAST-ACCESS PLAYBACK OPERATION

(71) Applicants: Jonathan Arme, Frankfort, IL (US); William J. Korbecki, Crystal Lake, IL (US); Thomas Steven Woods, Arlington Heights, IL (US); Brian Craig Peterson, Barrington, IL (US); Paul T. Stathacopoulos, San Carlos, CA (US); Mycal Elliott, Chicago, IL (US)

(72) Inventors: Jonathan Arme, Frankfort, IL (US); William J. Korbecki, Crystal Lake, IL (US); Thomas Steven Woods, Arlington Heights, IL (US); Brian Craig Peterson, Barrington, IL (US); Paul T. Stathacopoulos, San Carlos, CA (US); Mycal Elliott, Chicago, IL (US)

(73) Assignee: UNITED VIDEO PROPERTIES, INC., Santa Clara, CA (US)

(21) Appl. No.: 13/463,300

(22) Filed: May 3, 2012

(51) Int. Cl. H04N 5/76

(52) U.S. Cl. 386/344; 386/E05.041

(57) ABSTRACT

Systems and methods for preventing access to a segment of a media asset during a fast-access playback operation are provided. A media asset is retrieved from storage. A user request to perform a fast-access playback operation on the media asset is received. Information that identifies the segment of the media asset is retrieved. The information is generated based on input received from a crowd that includes a plurality of users that have previously consumed the media asset. The fast-access playback operation is automatically terminated before the segment is reached based on the retrieved information.

### BACKGROUND

Traditional systems allow users to fast-forward or rewind a media asset that is being accessed. However, these systems fail to take into account what content is presented to the user while performing the fast-forward or rewind operation. As a result, during the fast-forward or rewind operation, the user may be exposed to undesirable content that is part of the media asset, such as a spoiler.

### SUMMARY

In view of the foregoing, systems and methods for preventing access to a media asset segment during a fast-access playback operation in accordance with various embodiments of the present invention are provided.

In some embodiments, a user selection of a media asset may be received. The media asset may be retrieved from storage and presented to the user. A user request to perform a fast-access playback operation may be received. The fast-access playback operation may be a fast-forward, skip forward, rewind, or skip backwards operation.

In some embodiments, information that identifies a segment of a media asset may be retrieved. The information may specify a start time or end time of the segment as well as a type of the segment. The type of the segment may include data that indicates whether the segment includes spoiler or material that exceeds a content rating assigned to the media asset.

In some embodiments, the fast-access playback operation may be automatically terminated before the segment is reached based on the retrieved information. The fast-access playback operation may be automatically terminated by blacking out content of the media asset segment from being presented and/or blocking out audio of the media asset segment. Alternatively or in addition, the fast-access playback operation may be automatically terminated by resuming playback at normal playback speed from a point near the start or end of the segment.

In some embodiments, the retrieved information may be generated based on input received from a crowd of users that have previously consumed the media asset. In particular, the information may be retrieved from a social network site or generated locally. The information may be generated by compiling and processing messages posted to a remote server by users in the crowd. The remote server may be a server that hosts a blog, news site or social network.

In some embodiments, the media asset may include a sequence of consecutive plot portions and an advertisement portion. The segment may correspond to a first of the consecutive plot portions that follows a second of the consecutive plot portions in the sequence. The fast-access playback operation may be automatically terminated by automatically terminating the fast-access playback operation after the advertisement portion and the second of the consecutive plot portions and before the first of the consecutive plot portions.

In some embodiments, a parental control setting associated with the user requesting the fast-access playback operation is retrieved. Media asset information associated with the media asset indicates that access to the media asset does not violate the retrieved parental control setting. A determination is performed as to whether the segment includes content that violates the parental control setting. The fast-access playback operation may be automatically terminated in response to determining that the segment includes content that violates the parental control setting.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention

FIG. 4 is a diagram of an illustrative cross-platform interactive media system in accordance with another embodiment of the invention;

FIG. 5 shows an illustrative display screen of a fast-access playback operation being performed on a media asset in accordance with an embodiment of the invention;

FIGS. 6 and 7 show illustrative display screens of a fast-access playback operation being terminated automatically in accordance with an embodiment of the invention;

FIG. 8 shows an illustrative display screen of segment identification being performed by a user in a crowd of users in accordance with an embodiment of the invention;

FIG. 9 shows an illustrative display screen of segment identification being performed by a crowd of users using a data feed in accordance with an embodiment of the invention;

FIG. 10 shows illustrative database entries for identifying types of media asset segments in accordance with an embodiment of the invention;

FIG. 11 is a diagram of a process for identifying media asset segments using a data feed that includes messages from users in a crowd in accordance with embodiments of the invention; and

FIG. 12 is a diagram of a process for preventing access to a media asset segment during a fast-access playback operation in accordance with embodiments of the invention.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), messages from a crowd of users on a social network, messages from a crowd of users posted to a blog, genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. In some implementations, this data may be referred to as a data feed. As referred to herein the term “crowd” should be understood to mean any number of users greater than one.

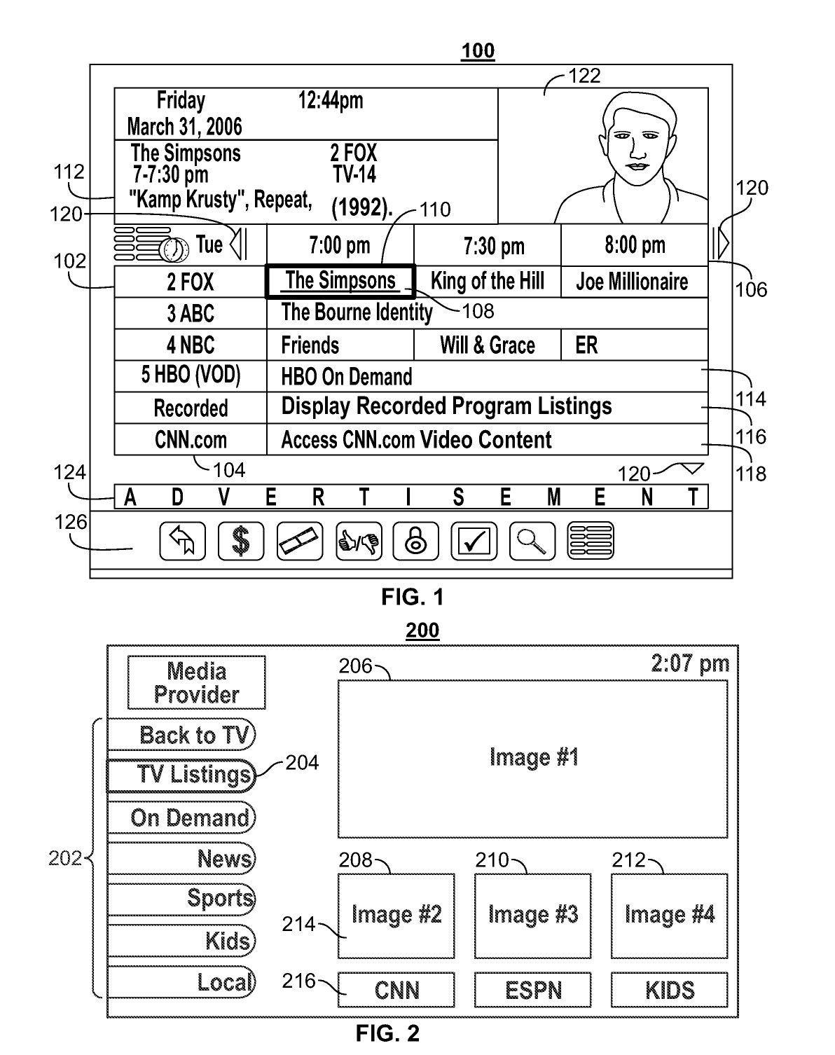

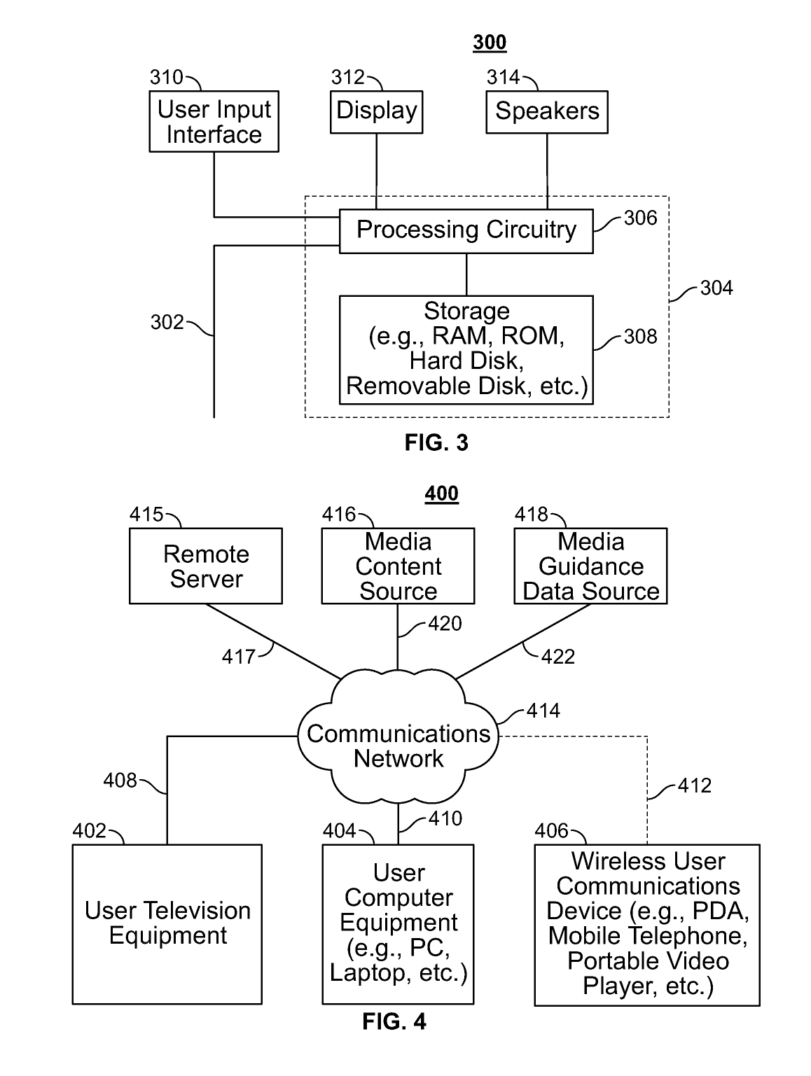

FIGS. 1-2 show illustrative display screens that may be used to provide media guidance data. The display screens shown in FIGS. 1-2 and 5-9 may be implemented on any suitable user equipment device or platform. While the displays of FIGS. 1-2 and 5-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

As referred to herein, the phrase “in response” should be understood to mean automatically directly and immediately as a result of or automatically based on the corresponding action where intervening inputs or actions may occur.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, identifying media asset segment start and end times and types of the media segments (e.g., a type that exceeds a content rating assigned to the media asset or a type that includes a spoiler), performing a fast-access playback operation or other features. As referred to herein, the term “spoiler” should be understood to mean a portion of a media asset plot that reveals an outcome to a previous portion of the plot. A spoiler may include a score or play performed in a portion of a sporting event (e.g., second half) that follows a previous portion (e.g., first half). Options available from a main menu display may include search options, VOD options (e.g., fast-access playback operations), parental control options, Internet options, cloud-based options, device synchronization options, second screen device options, options to access various types of media guidance data displays, options to subscribe to a premium service, options to edit a user's profile, options to access a browse overlay, or other options. As referred to herein, the phrase “fast-access playback operations” should be understood to mean any operation that pertains to playing back a non-linear media asset faster than normal playback speed or in a different order than the media asset is designed to be played, such as a fast-forward, rewind, skip, chapter selection, segment selection, skip segment, next segment, previous segment, skip advertisement, next chapter, previous chapter or any other operation that does not play back the media asset at normal playback speed. The fast-access playback operation may be any playback operation that is not “play,” where the play operation plays back the media asset at normal playback speed.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

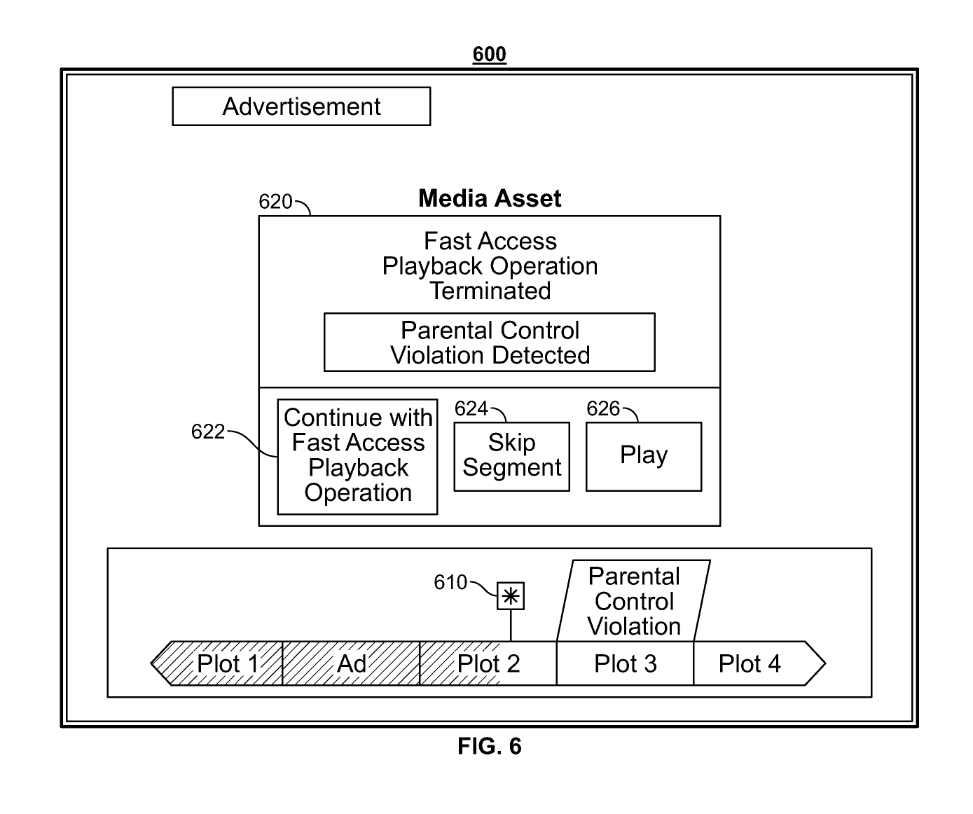

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

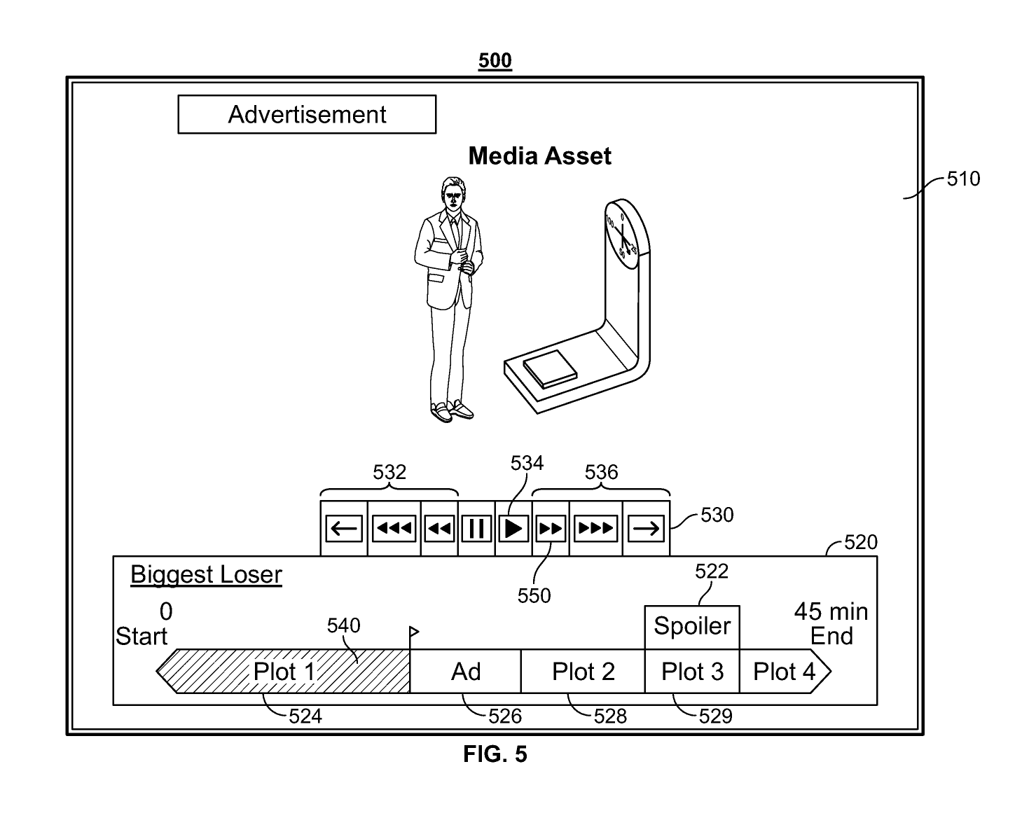

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

In some embodiments, a viewing history may be stored in storage 308 for a user. The viewing history may include indications of which media assets have been viewed by a given user. The viewing history may also include, for each media asset, which portion or portions have or have not been viewed by the user. In some implementations, the viewing history may include indications of which users in a group of users have seen or viewed a media asset or a particular segment of a media asset. The group of users may be users in a certain geographical location (e.g., in the same home) or users that are associated with each other on a social network.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. User input interface 310 may include keys or displayed options that enable a user to instruct control circuitry 304 to perform a fast-access playback operation. Specifically, each key or option displayed on user input interface 310 may correspond to a different fast-access playback operation. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Each user of the user equipment devices may be associated with different users in a crowd of users. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

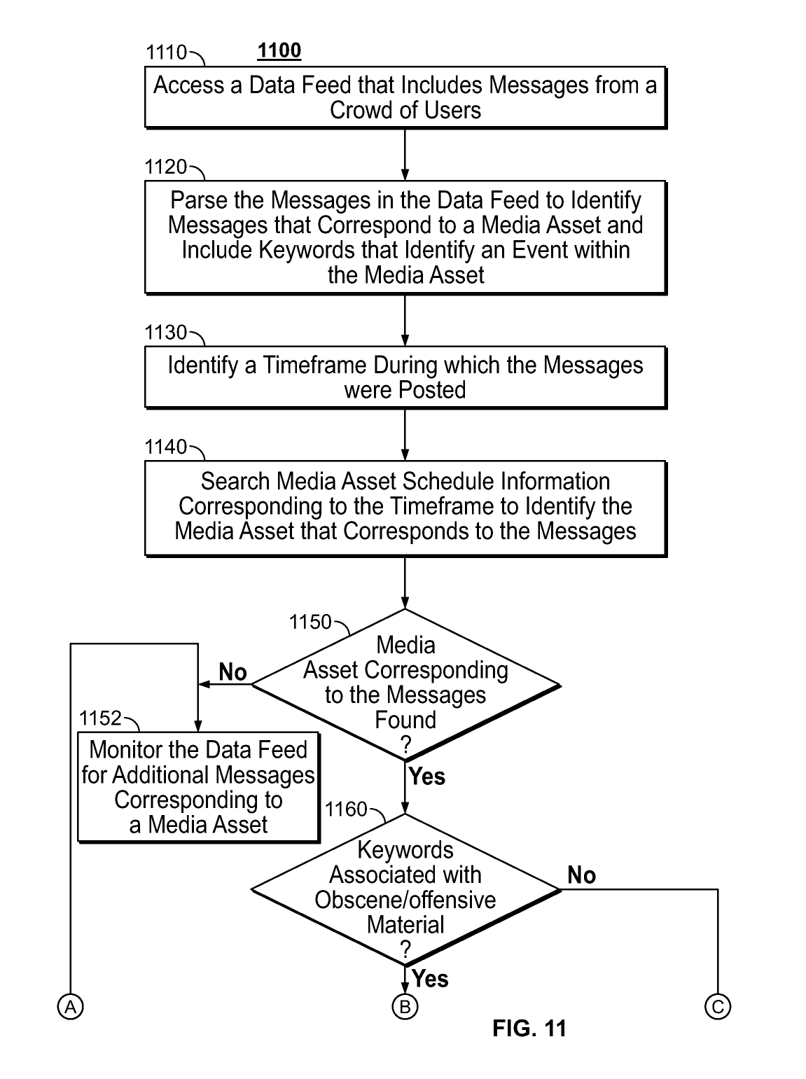

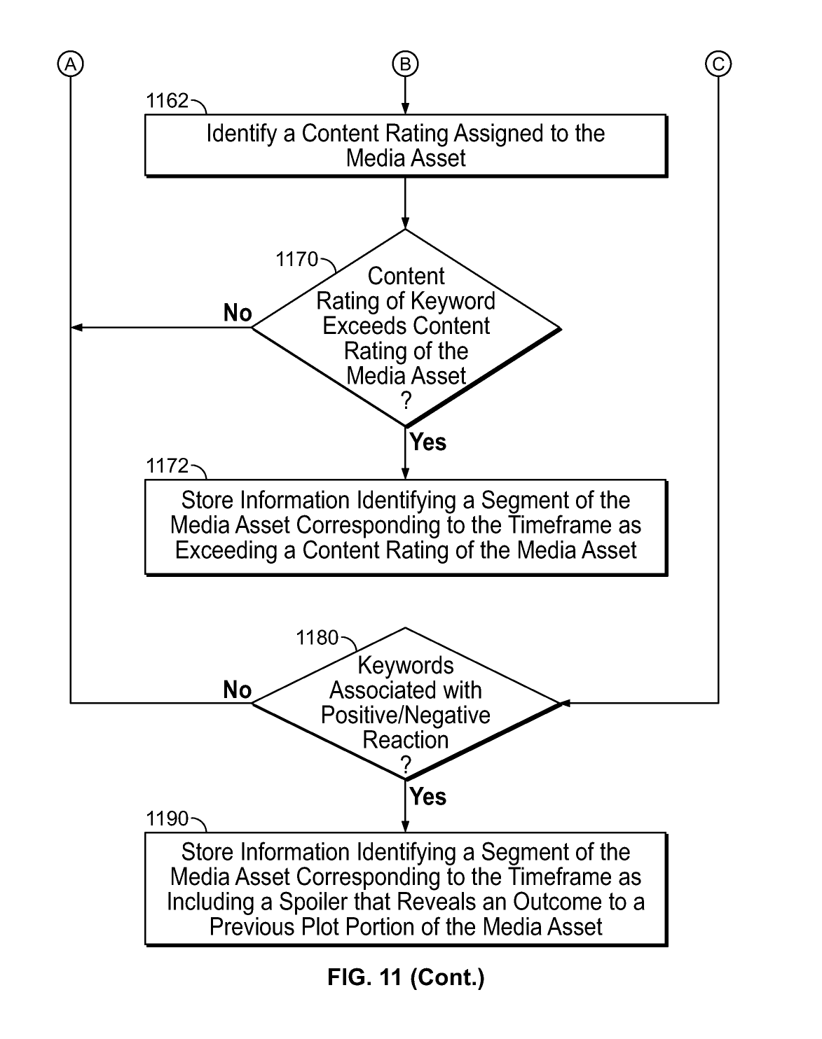

Media guidance data source 418 may provide media guidance data, such as the media guidance data described above. Media guidance application data may be provided to the user equipment devices using any suitable approach. Media guidance application data may include a data feed that includes messages from a plurality of users in a crowd. The messages in the data feed may be posted by the users in the crowd onto a social network, a blog, a news feed or any other medium in which multiple users may provide messages. In some implementations, the messages may include information that identify types of segments included in a media asset, such as whether a segment includes a spoiler or content that exceeds a content rating of the media asset. These messages are discussed in more detail below in connection with FIGS. 9 and 10. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of remote server 415. When executed by control circuitry of remote server 415 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, access to messages posted by users in a crowd, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, a remote server 415 coupled to communications network 414 may host a website, social network, blog and/or news site. Remote server 415 may include the same or similar circuitry or components as control circuitry 304. A crowd of users may post messages to remote server 415 that identify a media asset and a segment within the media asset. Remote server 415 may process the received messages to identify a starting and/or ending time of the segment within the media asset and a type of the media asset based on content of the messages. Remote server 415 may store the identification of the segment and the type of the segment as information that is made available to a user equipment device 300 during, before, or after a fast-access playback operation. User equipment device 300 may use the information received from remote server 415 to prevent access to the media asset segment during a fast-access playback operation.

In some embodiments, control circuitry 304 may retrieve a media asset (or portion of the media asset) from storage. Control circuitry 304 may present the retrieved media asset and receive a user request to perform a fast-access playback operation (e.g., fast-forward). Control circuitry 304 may retrieve information (e.g., from the cloud or a data feed) that identifies a segment or segments of the media asset as being of particular types. For example, the segment types may be spoilers or include content that exceeds a content rating assigned to the media asset. The information may be generated by a crowd of users who previous consumed the same media asset.

Control circuitry 304 may monitor a position within the media asset during the fast-access playback operation and automatically terminate the fast-access playback operation before the segment is reached. For example, when the segment is identified as a spoiler, control circuitry 304 may automatically resume playback of the media asset after automatically terminating the fast-access playback operation at a point that precedes the segment by an amount of time (e.g., 5 seconds) or that corresponds to another plot segment that precedes the segment having the spoiler.

In some embodiments, the media asset may be a previously stored sporting event (e.g., soccer or football game). Control circuitry 304 may retrieve and playback the media asset for the user. In response to receiving a request to perform a fast-access playback operation, control circuitry 304 may monitor a position within the media asset during the fast-access playback operation to determine whether a score or play (e.g., a game changing play) is displayed. For example, control circuitry 304 may determine whether an overlay is presented in a given segment that includes a score of the sporting event. In response to determining a score or play (e.g., a game changing play) is being presented at a position within or upcoming in the fast-access playback operation, control circuitry 304 may automatically terminate the fast-access playback operation before the score or play (e.g., a game changing play) is presented for the user. Alternatively or in addition, in response to determining a score or play is being presented at a position within or upcoming in the fast-access playback operation, control circuitry 304 may automatically determine in what position on the screen the score or play (e.g., a game changing play) is being displayed and block out (hide) the score or play from being presented for the user. Alternatively or in addition, in response to determining a score or play (e.g., a game changing play) is being presented at a position within or upcoming in the fast-access playback operation, control circuitry 304 may automatically block out (hide) the entire display or skip over that region to avoid presenting the score or play to the user.

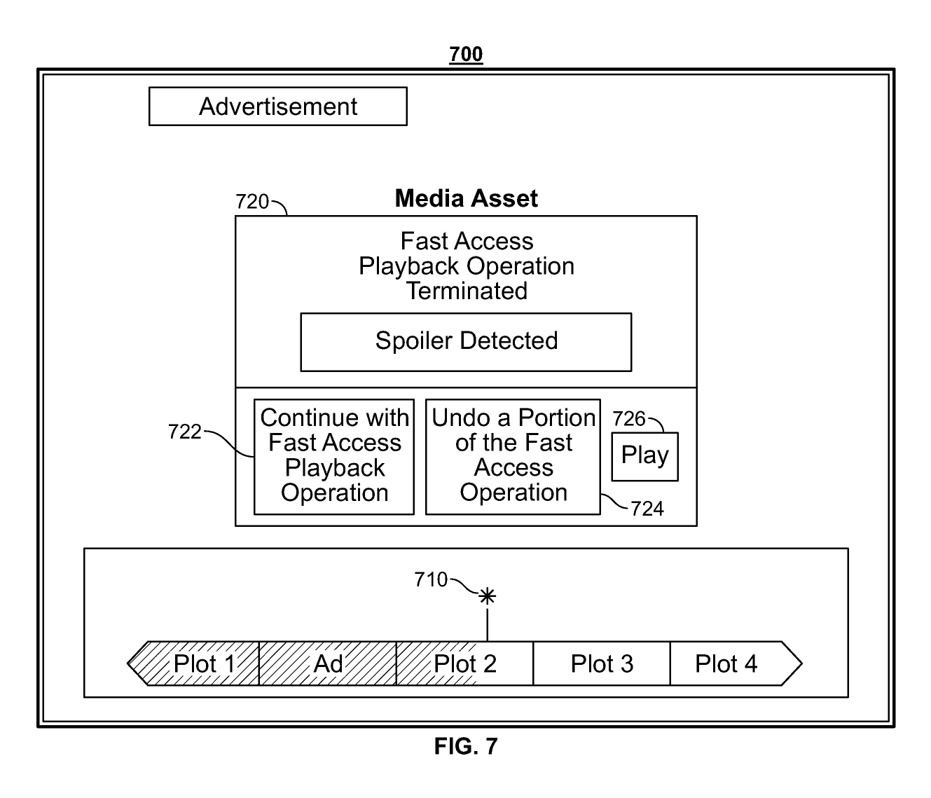

FIG. 5 shows an illustrative display screen 500 of a fast-access playback operation being performed on a media asset in accordance with an embodiment of the invention. Screen 500 includes a media asset 510, an overlay 520 and playback options region 530. Media asset 510 may be a non-linear media asset that is retrieved from storage. For example, media asset 510 may be a recording of a program that was transmitted previously. Media asset 510 may be divided into multiple portions or segments. Specifically, media asset 510 may include plot portions or segments and an advertisement portion or segment. In some implementations, media asset 510 may only include plot segments.

Control circuitry 304 may receive a user input requesting display of information about media asset 510. In response, control circuitry 304 may retrieve from storage information about media asset 510 and display the information in overlay 520. Overlay 520 may include a title of media asset 510 and any other suitable information about media asset 510 (e.g., description information, runtime, original scheduled transmission time, etc.). In some implementations, control circuitry 304 may display overlay 520 on top of media asset 510. In some implementations, control circuitry 304 may communicate the information about media asset 510 to a second screen device and instruct the second screen device to display overlay 520. In such circumstances, a full screen display of media asset 510 may continue to be provided on user equipment device 300 while overlay 520 is provided on the second screen device.

Overlay 520 may include a transport bar that visually depicts or indicates a current playback position within media asset 510 relative to a starting point and ending point of media asset 510. The transport bar may be divided into regions that represent the different portions or segments of media asset 510. For example, first region 524 may represent a first plot segment of media asset 510, second region 526 may represent an advertisement segment of media asset 510, third region 528 may represent a second plot segment of media asset 510, and third region 529 may represent a third plot segment of media asset 510. The representations provided in each region may uniquely identify the type of segment to which the region corresponds. For example, first region 524 may include a title of the first plot segment (e.g., a chapter name) and second region 526 may include an indication that an advertisement is present in that segment of media asset 510 (e.g., a name of a product or service being advertised, a logo, image or video of the advertised product or service).

The transport bar may include a viewed portion indicator 540. Indicator 540 may shade, visually indicate, or color a region in the transport bar which corresponds to a portion of media asset 510 that has been played back or viewed by the user. Similarly, another indicator (white space) in the transport bar may visually indicate to the user those portions of media asset 510 that have not been viewed or played back by the user.

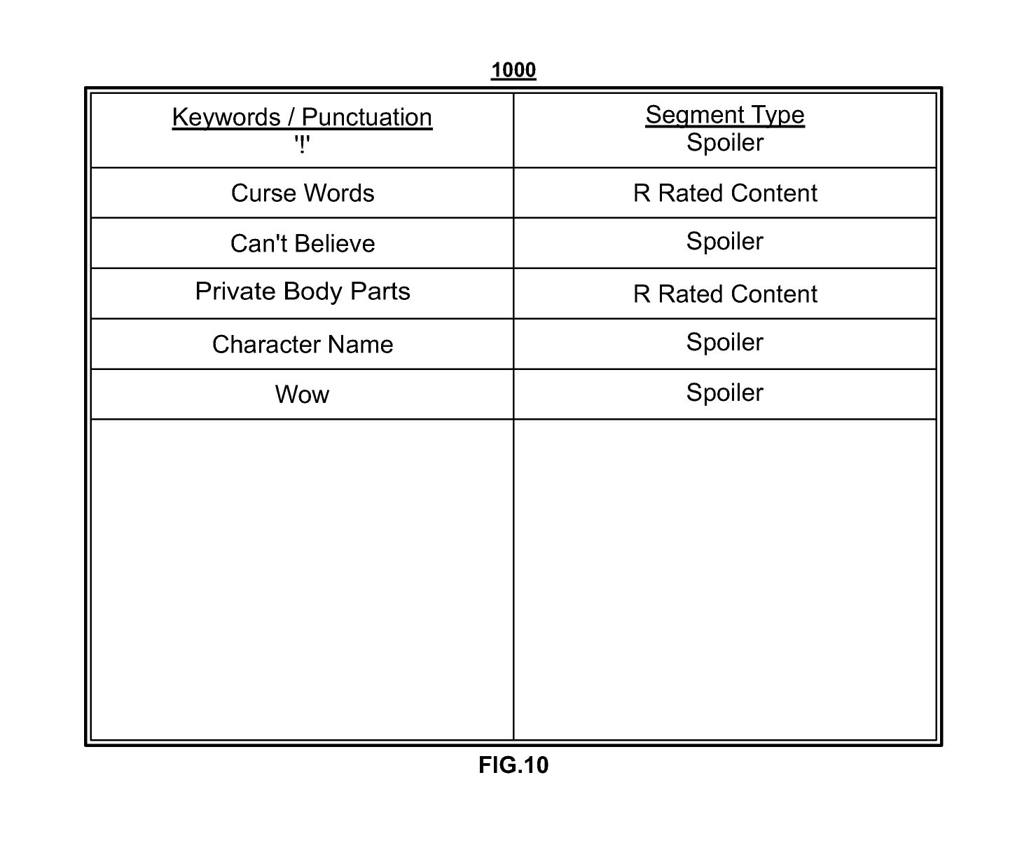

In some implementations, control circuitry 304 may determine a type for each plot segment of media asset 510. For example, control circuitry 304 may receive a information that is generated based on input received from a crowd of users that identifies types of segments in media asset 510. The crowd of users may be a plurality of users that have consumed (e.g., viewed, recorded, heard, or been exposed to) media asset 510 previous to the user. The types of segments identified by the information may indicate whether a particular segment includes a spoiler or includes content having a rating that exceeds a content rating assigned to media asset 510. Generation of the information that identifies types of the segments is discussed in more detail below in connection with FIGS. 8-11.

In some implementations, control circuitry 304 may generate for display in overlay 520 an indicator of the type of each plot segment of media asset 510 using the transport bar. For example, control circuitry 304 may determine using the retrieved information about the media asset that the third plot segment includes a spoiler. In response, control circuitry 304 may generate for display indicator 522 which informs the user where the spoiler is in relation to other plot segments. Specifically, indicator 522 may include the word “spoiler” and may be displayed on top or adjacent region 529 to indicate to the user which segment of media asset 510 includes the spoiler. Using indicator 522 the user may avoid being exposed to the spoiler or the third plot segment when performing a fast-access playback operation. Specifically, the user may see the current position indicator advancing towards the segment with the spoiler during a fast-access playback operation and may terminate the fast-access playback operation before reaching the segment with the spoiler.

In some implementations, control circuitry 304 may determine using the retrieved information about the media asset that the third plot segment includes a content that has a content rating that exceeds a content rating assigned to the media asset. In response, control circuitry 304 may generate for display an indicator which informs the user which region has the content rating that exceeds a content rating assigned to the media asset in relation to other plot segments. In some implementations, control circuitry 304 may only display such a content rating indicator in response to determining that the content rating of the third plot segment violates parental control settings of the user (e.g., that the third plot segment includes offensive material). For example, the indicator may include the words “parental control violation” and may be displayed on top or adjacent region 529 to indicate to the user which segment of media asset 510 includes content that violates the parental control settings. Using this indicator the user may avoid being exposed to the offensive material or the third plot segment when performing a fast-access playback operation. Specifically, the user may see the current position indicator advancing towards the segment with the offensive material during a fast-access playback operation and may terminate the fast-access playback operation after passing the segment with the offensive material.

Control circuitry 304 may receive a user input requesting to perform a playback operation on media asset 510. In response, control circuitry 304 may display playback operation options region 530 adjacent to overlay 520. Options region 530 may include various playback options that may be selected to perform a playback operation or a fast-access playback operation. Fast-access playback operations may include playback operations that progress (e.g., move playback of media asset 510 forward in time) or regress (e.g., moves playback of media asset 510 backwards in time) playback of media asset 510. Specifically, fast-access playback operation options 532 may include options that regress playback of media asset 510 and options 536 may include options that progress playback of media asset 510.

In some implementations, options 532 may include a first rate rewind option that, when selected, causes control circuitry 304 to playback media asset 510 backwards in time to a certain point at a faster rate than normal playback speed and a second rate rewind option that, when selected, causes control circuitry 304 to playback media asset 510 backwards in time to a certain point faster than first rate rewind option. Options 532 may include a skip backwards option that, when selected, causes control circuitry 304 to skip to a point that is a predetermined amount of time (e.g., 30 seconds) previous to the current playback position.

In some implementations, options 536 may include a first rate fast-forward option that, when selected, causes control circuitry 304 to playback media asset 510 forwards in time to a certain point faster than normal playback speed and a second rate fast-forward option that, when selected, causes control circuitry 304 to playback media asset 510 forwards in time to a certain point faster than first rate fast-forward option. Options 532 may include a skip forwards option that, when selected, causes control circuitry 304 to skip to a point that is a predetermined amount of time (e.g., 30 seconds) later than the current playback position.

Other options that are not discussed that may be included in region 530 include a chapter or segment selection option which enable a user to pick a particular segment to instruct control circuitry 304 to begin playback directly from the selected segment.

In some implementations, control circuitry 304 may display options region 530 on top of media asset 510. In some implementations, control circuitry 304 may communicate with a second screen device and instruct the second screen device to display options region 530 instead. In such circumstances, an uninterrupted display of media asset 510 may continue to be provided on user equipment device 300 while options region 530 is provided on the second screen device.

In some embodiments, control circuitry 304 may receive a user selection of fast-access option 550. In response, control circuitry 304 may advance playback at a rate greater than normal playback speed until a user request to terminate playback is received. Specifically, the user may desire to skip over an advertisement portion of media asset 510 more quickly than normal playback speed and thereby select option 550 to instruct control circuitry 304 to fast-forward through the advertisement portion. Control circuitry 304 may continue advancing playback until instructed by the user to stop. As a result, images or video or audio of media asset 510 may be presented to the user while performing the fast-access playback operation of the advertisement portion and any other portion of media asset 510 through which control circuitry 304 is advancing. In some implementations, the user may not instruct control circuitry 304 to terminate the fast-access playback operation and thus may be exposed to the third plot segment which follows the advertisement portion and the second plot segment. Being exposed to the third plot segment may be undesirable to the user (even if seen at a speed greater than normal playback speed) because the third plot segment may include a spoiler that reveals a result of a previous segment (e.g., the second segment). For example, the third plot segment may include a score or play of a sporting event that is more updated than the score or play that occurred in the first or second plot segment. Similarly, being exposed to the third plot segment may be undesirable to the user (even if seen at a speed greater than normal playback speed) because the third plot segment may include content which has a content rating that exceeds a content rating of media asset 510 and violates a parental control setting of the user.

For example, the second plot segment may include material that builds anticipation about an event in media asset 510 and the third plot segment may include the event (e.g., a plot twist). By not being exposed to the second plot segment the user's interest in the third plot segment is reduced as anticipation was not built or the user may be confused by the event presented in the third plot segment. Alternatively, the second plot segment may correspond to a first part of a sporting event and the third plot segment may correspond to a later second part of the sporting event with an updated score or game changing play. Being exposed to the third plot segment before the user is exposed to the second plot segment may reduce the user's desire to see the second plot segment entirely and negatively impact the viewing experience because the user would already know which team in the sporting event will score points and also the number of points each team will score. Similarly, the third plot segment may include nudity or other offensive material which violates parental control settings of the user and which is not generally within the scope of a content rating assigned to media asset 510. Exposing the user to the nudity or offensive material may offend the user's interests and therefore be undesirable.

In some embodiments, control circuitry 304 may automatically terminate the fast-access playback operation without the user specifically requesting that the operation be stopped to prevent exposing the user to the third plot segment during a fast-access playback operation. Specifically, control circuitry 304 may automatically terminate the fast-access playback operation when control circuitry 304 determines that a current position in the fast-access playback operation is substantially near the segment of the media asset that includes the spoiler or that includes content that violates a parental control setting. For example, control circuitry 304 may automatically black out or block from view the segment with the spoiler (e.g., block the score from being displayed on the screen or prevent an overlay with the score from being displayed) or the segment that violates a parental control setting. Alternatively or in addition, control circuitry 304 may automatically start playing back at normal playback speed a plot segment or other segment of media asset 510 that precedes the segment with the spoiler by a predetermined amount of time. Alternatively or in addition, control circuitry 304 may automatically start playing back at normal playback or jump over the segment that violates a parental control setting and playback at normal playback speed a plot segment of media asset 510 that does not violate the parental control setting. Alternatively or in addition, control circuitry 304 may automatically generate a prompt informing the user that the fast-access playback operation was terminated to avoid exposing the user to the segment with the spoiler or that violates the parental control settings.

In some embodiments, control circuitry 304 may retrieve from storage 308 a viewing history for the user requesting the fast-access playback operation. Control circuitry 304 may determine whether the user has viewed the segment of the media asset that includes the spoiler or that exceeds the parental control settings based on the viewing history for the media asset. In response to determining that the user has previously viewed the segment of the media asset that includes the spoiler or that exceeds the parental control settings, control circuitry 304 may continue performing the fast-access playback operation through the segment instead of automatically terminating the fast-access playback operation (e.g., instead of blacking out or blocking the segment or automatically playing back at normal playback speed the media asset from a position before the segment). In particular, performing the automatic termination of the fast-access playback operation (discussed above and below) may be conditioned upon information stored in a viewing history for the user. Specifically, the automatic termination may be conditioned on whether the user who is requesting the fast-access playback operation has viewed or seen the segment previously.

In some embodiments, a group of users may be viewing the media asset on a shared display screen (e.g., a television or monitor in a particular location such as a home). In such circumstances, control circuitry 304 may retrieve from storage 308 a viewing history for each user that is viewing the media asset on the shared display. Control circuitry 304 may determine whether any of the users in the group, has viewed the segment of the media asset that includes the spoiler or that exceeds the parental control settings based on the viewing history for the media asset. In response to determining that all of the users in the group have previously viewed the segment of the media asset that includes the spoiler or that exceeds the parental control settings, control circuitry 304 may continue performing the fast-access playback operation through the segment instead of automatically terminating the fast-access playback operation (e.g., instead of blacking out or blocking the segment or automatically playing back at normal playback speed the media asset from a position before the segment). In some implementations, control circuitry 304 may continue performing the fast-access playback operation through the segment instead of automatically terminating the fast-access playback operation in response to determining that a majority (e.g., more than half) of all of the users in the group has previously viewed the segment. In particular, performing the automatic termination of the fast-access playback operation (discussed above and below) may be conditioned upon information stored in a viewing history for all of the users in a given group. Specifically, the automatic termination may be conditioned on whether users in a group have viewed or seen the segment previously. In considering or basing the automatic termination of the fast-access playback operation on viewing histories for a group of users, control circuitry 304 may edit or base playback operations for a media asset on the current viewing audience rather than on an individual user.

In some embodiments, when a group of users is sharing access to a screen, control circuitry 304 may prevent a spoiler from being presented to one of the users in the group by blocking an audio portion of a media asset being presented to the one of the users. For example, control circuitry 304 may determine whether a segment of a media asset being viewed by a user includes a spoiler. Control circuitry 304 may perform such a determination based on information received from a crowd of users, information received from a remote server or any other suitable technique discussed above and below. Control circuitry 304 may monitor a position within the media asset being played back and determine based on the received information whether the position is near a segment that includes a spoiler. In response to determining that the segment of the media asset includes a spoiler, control circuitry 304 may retrieve a viewing history of the user to determine whether the user has previously seen the media asset for which the spoiler is discussed. When the user is determined to have not previously seen the media asset or spoiler being discussed in the media asset, control circuitry 304 may filter out only the audio portion of the media asset segment and so the video portion of the media asset segment continues to be displayed. This situation may arise in a multi-user context where each user in the group shares access to a display but has their own audio device (e.g., headphones) such as in a gym where multiple users watch the same screen and listen to the audio on their own devices. Each audio device may have its own storage 308 that includes a viewing history for the user and is configured to block the audio portion of the media asset that includes the segment with the spoiler if the user has not seen the media asset segment previously. Accordingly, other users in the group that have seen the segment continue to receive both the audio and the video portions of the media asset segment with the spoiler while the user who has not seen the media asset segment receives only the video portion but not the audio portion of the media asset segment.

In some embodiments, when a group of users is sharing access to a screen, control circuitry 304 may prevent a spoiler from being presented to only those users in the group that have not viewed the media asset segment with the spoiler. For example, users in the group may each wear or use a respective optical device (e.g., 3D glasses) to view the media asset on the shared screen. Control circuitry 304 may determine whether a segment of a media asset being viewed by a user includes a spoiler. Control circuitry 304 may perform such a determination based on information received from a crowd of users, information received from a remote server or any other suitable technique discussed above and below. Control circuitry 304 may monitor a position within the media asset being played back and determine based on the received information whether the position is near a segment that includes a spoiler. In response to determining that the segment of the media asset includes a spoiler, control circuitry 304 of each optical device may retrieve a viewing history of the user wearing or using the optical device to determine whether the user has previously seen the media asset for which the spoiler is discussed. When the user is determined to have not previously seen the media asset or spoiler being discussed in the media asset, control circuitry 304 may filter out only the video portion of the media asset segment using the user's optical device and so the audio portion of the media asset segment continues to be displayed. Accordingly, other users in the group that have seen the segment continue to receive both the audio and the video portions of the media asset segment with the spoiler while the user who has not seen the media asset segment receives only the audio portion but not the video portion of the media asset segment.

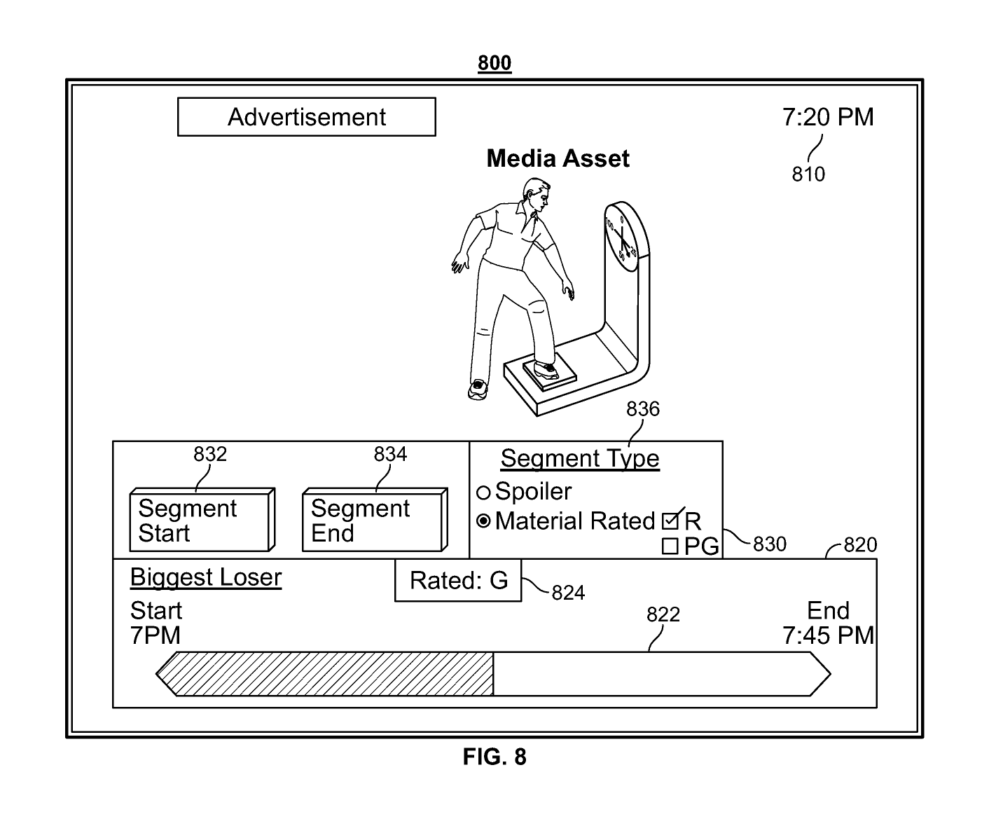

FIG. 6 shows an illustrative display screen 600 of a fast-access playback operation being terminated automatically in accordance with an embodiment of the invention. Screen 600 includes a prompt 620 that indicates to the user that the fast-access playback operation was automatically terminated. Specifically, control circuitry 304 may determine based on the retrieved information that the third segment includes content that violates a parental control setting and may also determine a start time of the third segment. In addition, control circuitry 304 may monitor the current position of playback during the fast-access playback operation to determine whether the current position is substantially near a start of the segment that violates the parental control settings. For example, control circuitry 304 may determine that the current position is within 15 seconds of the start of the segment that violates the parental control settings while performing the fast-access playback operation. In response, control circuitry 304 may automatically terminate the fast-access playback operation and generate for display prompt 620.

Prompt 620 may include information that indicates a reason why control circuitry 304 automatically terminated the fast-access playback operation. For example, prompt 620 may indicate that control circuitry 304 determined that a segment that is substantially near a playback position reached during the fast-access playback operation (e.g., is within 15 seconds of the playback position) includes content that violates a parental control setting. Control circuitry 304 may generate for display in prompt 620 a continue option 622, a skip segment option 624 and a play option 626.

In response to receiving a user selection of continue option 622, control circuitry 304 may return to the fast-access playback operation. Accordingly, the user may be exposed to the segment that violates parental control settings during the fast-access playback operation. For example, in response to receiving a user selection of continue option 622, control circuitry 304 may continue the fast-forward operation to present in an accelerated display rate the next segments of the media asset that follow the point of termination of the fast-forward operation.

In response to receiving a user selection of skip segment option 624, control circuitry 304 may automatically jump over the segment that violates parental control settings. Control circuitry 304 may resume normal playback at the next segment that follows the segment with that violates the parental control settings, as such the user may not be exposed to the content that violates the parental control settings. Alternatively, control circuitry 304 may resume the fast-access playback operation start with the next segment that follows the segment with that violates the parental control settings; as such the user may not be exposed to the content that violates the parental control settings.

In response to receiving a user selection of play option 626, control circuitry 304 may resume playing back the media asset at a normal playback speed. Accordingly, the user may be exposed to the segment that violates parental control settings.

In some implementations, control circuitry 304 may generate for display in the transport bar a visual indicator 610 that identifies the position within media asset 510 at which the fast-access playback operation was automatically terminated. Visual indicator 610 may uniquely identify to the user the reason why the fast-access playback operation was automatically terminated. For example, visual indicator 610 may be an asterisk surrounded by a box to indicate that control circuitry 304 automatically terminated the fast-access playback operation in response to determining that a segment of media asset that is substantially near a playback position reached during the fast-access playback operation (e.g., is within 15 seconds of the playback position) includes content that violates a parental control setting. Any other suitable visual indication may be provided.

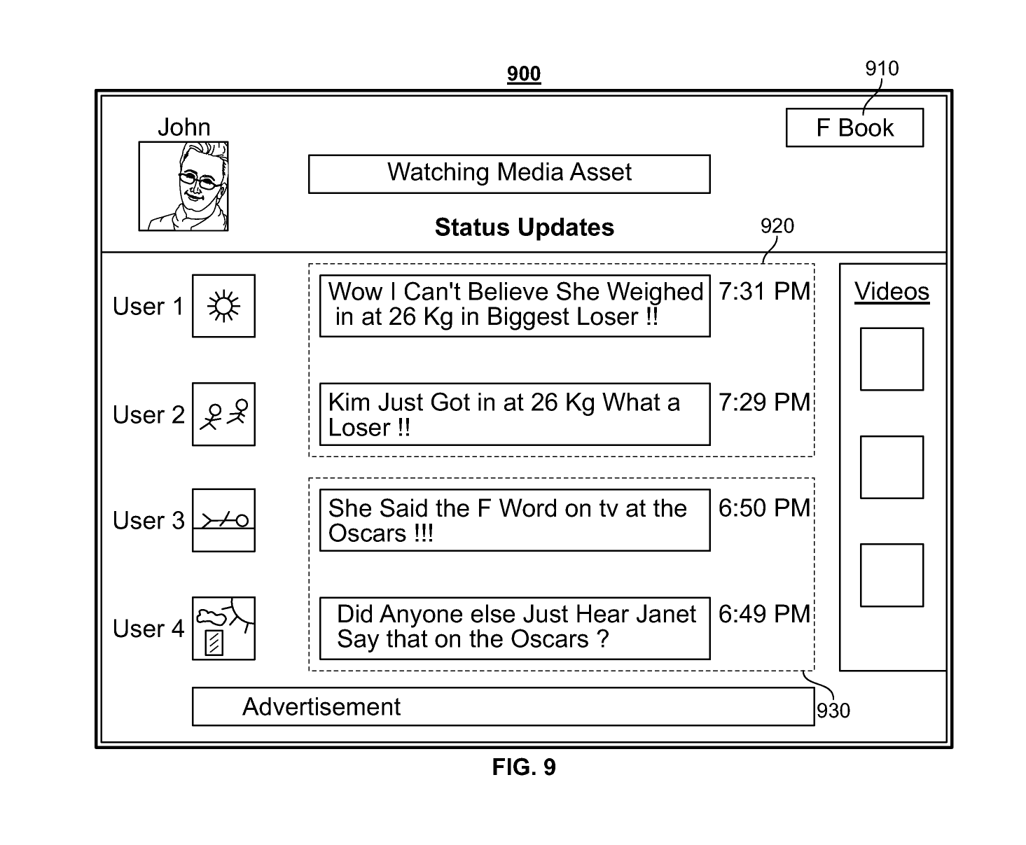

FIG. 7 shows an illustrative display screen 700 of a fast-access playback operation being terminated automatically in accordance with an embodiment of the invention. Screen 700 includes a prompt 720 that indicates to the user that the fast-access playback operation was automatically terminated. Specifically, control circuitry 304 may determine based on the retrieved information that the third segment includes a spoiler and may also determine a start time of the third segment. In addition, control circuitry 304 may monitor the current position of playback during the fast-access playback operation to determine whether the current position is substantially near a start of the segment that includes the spoiler. For example, control circuitry 304 may determine that the current position is within 15 seconds of the start of the segment that includes the spoiler while performing the fast-access playback operation. In response, control circuitry 304 may automatically terminate the fast-access playback operation and generate for display prompt 720.

Prompt 720 may include information that indicates a reason why control circuitry 304 automatically terminated the fast-access playback operation. For example, prompt 720 may indicate that control circuitry 304 determined that a segment that is substantially near a playback position reached during the fast-access playback operation (e.g., is within 15 seconds of the playback position) includes a spoiler. Control circuitry 304 may generate for display in prompt 720 a continue option 722, a undo option 724 and a play option 726.

In response to receiving a user selection of continue option 722, control circuitry 304 may return to the fast-access playback operation. Accordingly, the user may be exposed to the segment that includes the spoiler during the fast-access playback operation. For example, in response to receiving a user selection of continue option 722, control circuitry 304 may continue the fast-forward operation to present in an accelerated display rate the next segments of the media asset that follow the point of termination of the fast-forward operation.

In response to receiving a user selection of undo option 724, control circuitry 304 may automatically resume playback at normal playback speed from a position that precedes the point at which control circuitry 304 terminated the fast-access playback operation by a predetermined amount of time (e.g., 15 seconds). For example, the fast-access playback operation may be a fast-forward operation that is automatically terminated at the end of the second plot segment and just before the start of the third segment which includes the spoiler. In response to receiving the user selection of undo option 724, control circuitry 304 may automatically rewind the termination position by an amount of time (e.g., 15 seconds) such that the playback is resumed from a point 15 seconds before the start of the third plot segment.

In response to receiving a user selection of play option 726, control circuitry 304 may resume playing back the media asset at a normal playback speed. Accordingly, the user may be exposed to the segment that includes the spoiler.

In some implementations, control circuitry 304 may generate for display in the transport bar a visual indicator 710 that identifies the position within media asset 510 at which the fast-access playback operation was automatically terminated. Visual indicator 710 may uniquely identify to the user the reason why the fast-access playback operation was automatically terminated. For example, visual indicator 710 may be an asterisk to indicate that control circuitry 304 automatically terminated the fast-access playback operation in response to determining that a segment of media asset that is substantially near a playback position reached during the fast-access playback operation (e.g., is within 15 seconds of the playback position) includes a spoiler. Any other suitable visual indication may be provided.

In some embodiments, a crowd of users may identify start and/or end points of the segment of a media asset that includes a spoiler or content that exceeds a content rating assigned to the media asset. In particular, each user in the crowd may transmit to a remote server 415 or provider of the media asset a starting time and/or ending time of the segment. Remote server 415 may aggregate all of the input received from the crowd of users (e.g., after a predetermined number of users have provided the input). Remote server 415 may aggregate all of the input by computing an average of the start times specified by the crowd of users and/or an average of the end times specified by the crowd of users. Remote server 415 may store the average start time and/or average end time as the information that is provided to control circuitry 304. Remote server 415 may also include any other information about the media asset (e.g., total playback time, media asset rating, title, description, etc.) in the stored information. Control circuitry 304 may use the information received from the remove server 415 to determine a playback position of the segment that includes the spoiler or that violates a parental control setting to automatically terminate a fast-access playback operation.

FIG. 8 shows an illustrative display screen 800 of segment identification being performed by a user in a crowd of users in accordance with an embodiment of the invention. The crowd of users may be users that have consumed the media asset displayed in screen 800 before the user which is requesting a fast-access playback operation in FIGS. 5-7. Screen 800 includes a media asset, an information overlay 820, and a segment identification region 830.

The media asset displayed in screen 800 may be a linear or non-linear media asset. For example, in some implementations, the media asset may be a live broadcast of an event. Specifically, the current time 810 may indicate a current time of 7:20 PM and the media asset may be transmitted to a plurality of users or made available to a plurality of users between 7 PM and 7:45 PM. A user in the crowd may be consuming the media asset and provide input to control circuitry 304 requesting additional information. In response, control circuitry 304 may generate for display information overlay 820. Information overlay 820 may include any information identifying or describing the media asset (e.g., a title, detailed description, content rating, etc.) and a transport bar 822. Transport bar 822 may indicate to the user a current position within the media asset relative to a start and end time of the media asset.

While the user in the crowd is consuming the media asset, the user in the crowd of users may indicate to control circuitry 304 the desire to identify a segment. In response, control circuitry 304 may display segment identification region 830. For example, the user may be watching the media asset and determine that the content being presented exceeds a content rating 824 assigned to the media asset. Specifically, content rating 824 assigned to the media asset may be G (general audience) and the content being presented may include nudity and/or explicit material. Since the nudity and/or explicit material is typically associated with a rating of R (restricted audience), the user may determine that the rating of the content being presented at a particular playback position exceeds content rating 824 assigned to the media asset. In such circumstances, the user may use input interface 310 and press a suitable button requesting to identify a segment of the media asset. In response, control circuitry 304 may display segment identification region 830. In some implementations, control circuitry 304 may display segment identification region 830 persistently throughout presentation of the media asset, at predetermined or user defined intervals (e.g., every 5 minutes), after a commercial break, in response to a user request for information, together with overlay 820, or any combination thereof.

Segment identification region 830 may include a segment start option 832, segment end option 834, and segment type region 836. In response to receiving a user selection of segment start option 832, control circuitry 304 may identify a current playback position within the media asset and store the position in storage 308 as the start point of the segment. In some implementations, in response to receiving the user selection of option 832, control circuitry 304 may store a position that precedes the current playback position by a predetermined amount of time (e.g., 5-10 seconds) in storage 308. This may be useful to make up for human reaction time delays in providing input that marks the start of the segment.

In response to receiving a user selection of segment end option 834, control circuitry 304 may identify a current playback position within the media asset and store the position in storage 308 as the end point of the segment. In some implementations, in response to receiving the user selection of option 834, control circuitry 304 may store a position that precedes the current playback position by a predetermined amount of time (e.g., 5-10 seconds) in storage 308. This may be useful to make up for human reaction time delays in providing input that marks the start of the segment.

Segment type region 836 may include options that allow a user to specify what type of segment is being marked or identified by segment start and end options 832 and 834. For example, the user may select an option in region 836 that indicates to control circuitry 304 that the segment being identified includes a spoiler. The user may also specify the location on the screen that includes the spoiler (e.g., the location on the screen where the score of a sporting event is displayed). In some implementations, the user may select an option in region 836 that indicates to control circuitry 304 that the segment being identified includes material or content that has a content rating that exceeds content rating 824 assigned to the media asset. In such circumstances, the user may also provide a suggested content rating for the segment (e.g., R or PG).

In response to receiving a user selection of segment end option 834, control circuitry 304 may generate a message that includes the starting point generated in response to segment start option 832 being selected and the ending point generated in response to segment end option 834 being selected. Control circuitry 304 may include other information that uniquely identifies the media asset being consumed by the user in the message (e.g., any information included in overlay 820 and/or other information not included in overlay 820). Control circuitry 304 may retrieve data or information provided by the user in segment type region 836 and may include that data or information in the generated message. In some implementations, control circuitry 304 may only include the segment starting point with the segment type information in the message. In some implementations, control circuitry 304 may only include the segment ending point with the segment type information in the message. In some implementations, control circuitry 304 may only include the segment starting point and segment ending point without the segment type in the message. In some implementations, control circuitry 304 may only include the segment starting point without the segment type in the message.

In some implementations, control circuitry 304 may only include the segment ending point without the segment type in the message. Control circuitry 304 may transmit the generated message to a remote server that collects similar messages from other users in the crowd of users.

In some embodiments, a remote server may collect messages received from various users in a crowd that identify start/end points of segments within a media asset and types of those segments. Remote server 415 may include processing circuitry similar to control circuitry 304. Control circuitry 304 of remote server 415 may count the number of messages received from the users in the crowd for a given media asset. Specifically, control circuitry 304 of remote server 415 may parse each message that is received to identify the corresponding media asset. Control circuitry 304 of remote server 415 may increment a counter for the media asset corresponding to the message. In response to determining that a predetermined number of messages (e.g., 100 messages) have been received for a give media asset, control circuitry 304 may collectively process the messages to identify start/end times and types of segments within the media asset.

In some embodiments, control circuitry 304 of remote server 415 may compute an average of all the start times included in the messages received from the users in the crowd. Control circuitry 304 of remote server 415 may store the average of the start times as the start time of a segment in the media asset. Control circuitry 304 of remote server 415 may compute an average of all the end times included in the messages received from the users in the crowd. Control circuitry 304 of remote server 415 may store the average of the end times as the end time of a segment in the media asset. Control circuitry 304 of remote server 415 may assign a type to the segment identified by the average start/end times as the type indicated by a majority of the messages that are received. For example, if more than half of the messages received indicate the segment to include a spoiler and the remaining messages indicate the segment to include material that exceeds a content rating, control circuitry 304 of remote server 415 may assign the segment type as a spoiler.

In some implementations, in response to determining that more than half of the messages received indicate that the segment includes material that exceeds a content rating assigned to the media asset, control circuitry 304 of remote server 415 may determine a content rating to assign to the segment. Control circuitry 304 of remote server 415 may determine which content rating for the media asset portion is suggested by a majority of the messages. In response, control circuitry 304 of remote server 415 may associate the segment type as including material that exceeds the content rating assigned to the media asset and associate the suggested content rating with the segment. For example, if 30 percent of the messages suggest a “PG” content rating to the material in the segment, 40 percent of the messages suggest a “R” content rating to the material in the segment and 30 percent of the messages suggest a “X” content rating to the material in the segment, control circuitry 304 of remote server 415 may associate the segment with a “R” content rating. This is because the majority of the messages suggested a “R” content rating for the segment.

Control circuitry 304 of remote server 415 may store as information associated with the media asset the data that is generated based on the input messages received from the crowd of users. Specifically, control circuitry 304 of remote server 415 may store as the information a starting point, ending point and type of a segment within the media asset. Control circuitry 304 may deliver or make available the stored information to a user who requests access or retrieval of the media asset associated with the information. Control circuitry 304 of a device used to access the media asset may use the retrieved information to automatically terminate a fast-access playback operation (e.g., to avoid exposing the user to the segment identified by the information), as discussed in connection with FIGS. 5-7.

In some embodiments, a crowd of users may post information to a social network, blog or news site on the Internet about a segment of a media asset that includes a spoiler or content that exceeds a content rating assigned to the media asset. In particular, each user in the crowd may transmit to one or more remote servers, which host the social network, blog or news site, a message that includes content relating to a segment of the media asset. Remote server 415s or another source may analyze and process the messages posted by the users in the crowd of users to identify the media asset associated with the segment, a start/end times of the segment within the media asset and a type of the segment (e.g., whether the segment includes a spoiler or includes material that exceeds a content rating of the media asset). Remote server 415 may store the processed data as the information that is provided to control circuitry 304 of a device for which a user requests to perform the fast-access playback operation. Remote server 415 may also include any other information about the media asset (e.g., total playback time, media asset rating, title, description, etc.) in the stored information. Control circuitry 304 of a device for which a user requests to perform the fast-access playback operation may use the information received from the remove server to determine a playback position of the segment that includes the spoiler or that violates a parental control setting to automatically terminate a requested fast-access playback operation.

FIG. 9 shows an illustrative display screen 900 of segment identification being performed by a user in a crowd of users in accordance with an embodiment of the invention. Screen 900 includes a first message display region 920 and a second message display region 930.

Screen 900 may be a display generated by a remote server of a social network site, a blog, and/or a news site. For example, in response to a user in a crowd accessing the social network site, screen 900 may be presented that includes messages posted by a crowd of users. Screen 900 may include a logo 910 that identifies the social network site, blog and/or news site that is accessed. Although the above and below embodiments are described in the context of a social network site, blog or news site, the teachings are applicable to any service hosted by a server (optionally over the Internet) where a plurality of users can post and share messages about content and/or events. Messages posted to the social network site may be publicly available to any user, available only to users within a crowd, or users specifically identified by the user who is posting the message.

In some embodiments, region 920 may include messages from users in a crowd relating to a spoiler segment of a media asset. For example, the messages in region 920 may include comments or text, images or content submitted by users in the crowd that express thoughts of the users about a segment in the media asset that includes a spoiler.

In some embodiments, a first user may post a first message to remote server 415. The first message may be displayed by remote server 415 in a social feed for a plurality of users in region 920. The first message may be posted by the first user to remote server 415 using a second screen device. For example, the first user may be viewing a media asset and may wish to share thoughts about an event that has occurred in the media asset. Specifically, the first user may wish to share their thoughts about a spoiler segment in the media asset. Accordingly, the first user may using a second screen device login to the social network and transmit a message about the media asset to remote server 415 while continuing to watch the media asset. The message may include text that expresses the first user's surprise at the outcome in a particular segment. For example, the text may include a current score in a sporting event with an exclamation mark indicating the user's surprise that a given team scored certain points or made a certain play. In some implementations, the message may include a title of the media asset or other information that is unique to the media asset being consumed (e.g., character names, scenery information, scheduled transmission times, etc.). Remote server 415 may process the message and post the message to the first user's social network and may include a time stamp with the first message to indicate a time at which the first user posted the message.

In some embodiments, at about the same time as the first user, a second user may post a second message to the remote server. The second message may be displayed by remote server 415 in a social feed for a plurality of users in region 920. The second message may be posted by the second user to remote server 415 using a second screen device or another user equipment device 300. The second user may wish to share their thoughts about a spoiler segment in the same media asset as the first user. Accordingly, the second user may using a second screen device login to the social network and transmit a message about the media asset to remote server 415 while continuing to watch the media asset. The message may include text that expresses the second user's interest in the outcome of a segment in the media asset. In some implementations, the message may include a title of the media asset or other information that is unique to the media asset being consumed (e.g., character names, scenery information, scheduled transmission times, etc.). Remote server 415 may process the message and post the message to the second user's social network and may include a time stamp with the second message to indicate a time at which the second user posted the message.

In some embodiments, region 930 may include messages from users in a crowd relating to content in the media asset that has a rating that exceeds a rating assigned to the media asset. For example, the messages in region 930 may include comments or text, images or content submitted by users in the crowd that express thoughts of the users about a segment in the media asset that includes material that exceeds a rating assigned to the media asset.

In some embodiments, a third user may post a third message to remote server 415. The third message may be displayed by remote server 415 in a social feed for a plurality of users in region 930. The third message may be posted by the third user to remote server 415 using a second screen device. For example, the third user may be viewing a media asset and may wish to share thoughts about an event that has occurred in the media asset. Specifically, the third user may wish to share their thoughts about a segment in the media asset that includes material that exceeds a content rating assigned to the media asset. Accordingly, the third user may using a second screen device login to the social network and transmit a message about the media asset to remote server 415 while continuing to watch the media asset. The message may include text that expresses the third user's surprise at the material presented in a particular segment of the media asset. For example, the user's message may comment on nudity or obscene language (typically associated with a content rating of “R”) that was presented in a media asset that has a content rating of “G” and thereby exceeds the content rating assigned to the media asset. In some implementations, the message may include a title of the media asset or other information that is unique to the media asset being consumed (e.g., character names, scenery information, scheduled transmission times, etc.). Remote server 415 may process the message and post the message to the third user's social network and may include a time stamp with the third message to indicate a time at which the third user posted the message.

In some embodiments, at about the same time as the third user, a fourth user may post a fourth message to remote server 415. The fourth user may be the same user as the first user that submitted the message posted in region 920. The fourth message may be displayed by remote server 415 in a social feed for a plurality of users in region 930. The fourth message may be posted by the fourth user to remote server 415 using a second screen device or another user equipment device 300. The fourth user may wish to share their thoughts about a segment in the same media asset as the third user that the fourth user believes includes content that exceeds a content rating assigned to the media asset. Accordingly, the fourth user may using a second screen device login to the social network and transmit a message about the media asset to remote server 415 while continuing to watch the media asset. The message may include text that expresses the fourth user's disappointment in the material or content in a segment in the media asset. In some implementations, the message may include a title of the media asset or other information that is unique to the media asset being consumed (e.g., character names, scenery information, scheduled transmission times, etc.). Remote server 415 may process the message and post the message to the fourth user's social network and may include a time stamp with the fourth message to indicate a time at which the fourth user posted the message.

In some embodiments, each user that posts messages to the social network may be associated with a different group of friends in the social network. Accordingly, the messages submitted by the users in the crowd(s) may be presented together or separately depending on who is viewing the social feed of the social network. For simplicity, this disclosure is described in the context of all the users being associated with the same group of friends and thereby all the messages discussed in connection with FIG. 9 are displayed together.

Although region 920 and region 930 are shown as being separate, it should be understood that messages shown in the social network may be arranged in any suitable manner (e.g., chronologically or according to relationships between users). For example, if a message in region 930 was received before a message in region 920, the message in region 920 may be displayed below the message in region 930. The regions in display 900 are shown separately for simplicity and not limitation. Also, the users that post messages for display in region 920 and region 930 may belong to the same crowd or a different crowd of users. There may also be overlap between some users of the two crowds that submit messages for display in regions 920 and 930. For example, a first crowd of users may post messages relating to a spoiler segment in a first media asset and a second crowd of users may post messages relating to material in a segment that exceeds a content rating assigned to a second media asset. Specifically, the first crowd may include four users and the second crowd may include five users. One of the four users in the first crowd may be the same as one of the five users in the second crowd.

In some embodiments, remote server 415 may analyze messages posted to the social network to identify a media asset corresponding to some of the messages, a segment within the identified media asset and a type associated with that segment. In some implementations, remote server 415 may sort the messages according to a time at which the messages were posted. Remote server 415 may search for messages that were all submitted within a predetermined amount of time (e.g., within 10 minutes) of each other.

In some implementations, remote server 415 may automatically process text or content within the messages to identify keywords that identify a media asset being discussed in the message. Remote server 415 may automatically cross-reference keywords within the message with media assets scheduled for transmission at about the time when the messages were posted. For example, remote server 415 may determine that four different media assets were scheduled for transmission at about the time the messages were posted. Remote server 415 may retrieve from memory a data structure of those media assets that include a detailed description, title, summaries, character names and any other information associated with a media asset. Remote server 415 may determine whether any of the data in the data structures of the media assets match text identified in the messages. In response to determining that a match exists for one of the media assets, remote server 415 determine that the media asset associated with the message is the media asset that has the data structure with data that matches the text of the messages.

For example, a media asset (e.g., Biggest Loser) may include a data structure that specifies Kim as a character and one of the messages posted to the server may include text that includes the word Kim. Accordingly, remote server 415 may determine that the media asset associated with the message is Biggest Loser since the character in the media asset has a name that is the same or similar as the name discussed in the message posted by the user at about the time Biggest Loser is scheduled for transmission. Remote server 415 may perform a similar analysis for title or portions of the title of a media asset matching a title or portion of the title in a message from a user or any other field associated with the media asset.

In some embodiments, remote server 415 may cross-references words in the messages with a database of words to determine the media asset associated with the messages. For example, a database may include a list of words and their corresponding media asset. When remote server identifies a match between one of the words in the message and a give one of the words in the database, remote server 415 may determine what media asset is associated with the message.

In some embodiments, remote server 415 may parse each message posted to the social network and extract one or more words from each message. Remote server 415 may automatically generate an SQL query or instruction that includes the extracted words and transmit the query or instruction to media asset database. The media asset database may execute the instructions of the query and identify one or more media assets associated with the words in the query. The media asset database may transmit information back to remote server 415 identifying the media asset(s) associated with the words in the query. Remote server 415 may store an indication with each corresponding message, information that identifies the media asset(s) returned by the database.

In some embodiments, after remote server 415 determines what media asset is associated with each message, remote server 415 may store an indication in a database of which messages correspond to the media asset. The database may be used to generate the information that identifies the media asset, the segment of the media asset and the type of the segment for provision to control circuitry 304.

In some embodiments, an operator at remote server 415 may monitor the messages being posted to the social network. The operator may associate with each message an indication of the media asset with which the media asset is associated. In some implementations, the operator may also specify a type of the segment associated with the message and/or the start/end times of the segment and/or a display position in the screen of the spoiler in the segment on the screen. This information may be stored and used by remote server 415 to generate the information for transmission to control circuitry 304 for preventing access to the segment during a fast-access playback operation.

In some embodiments, remote server 415 may automatically process the times when each message corresponding to a particular media asset was received to determine start/end times of the media asset segment discussed in the messages. For example, remote server 415 may retrieve the posting times of each message that corresponds to a particular media asset. Remote server 415 may compute an average of the posting times. In some implementations, remote server 415 may store the computed average in the database associated with the media asset as the start time of the segment of the media asset. In some implementations, remote server 415 may store a time that precedes the computed average by a predetermined amount (e.g., five seconds) in the database associated with the media asset as the start time of the segment of the media asset.

In some implementations, remote server 415 may automatically determine an end time of the segment based on the computed start time. For example, remote server 415 may store a time that follows the determined start time by a predetermined amount (e.g., five minutes) in the database associated with the media asset as the end time of the segment of the media asset. In some implementations, remote server 415 may assign as the end time of the segment, the start time of the next chapter or plot portion of the media asset. This end time may be stored as the end time of the segment in the database.

In some embodiments, an operator at remote server 415 may monitor the messages being posted to the social network to identify a start/end time of a segment being discussed in the messages. The operator may associate with each message an indication of a start time and/or an end time of the segment associated with the media asset. This start/end time information may be stored and used by remote server 415 to generate the information for transmission to control circuitry 304 for preventing access to the segment during a fast-access playback operation.

In some implementations, remote server 415 may automatically determine a type associated with the segment. Remote server 415 may extract keywords from the messages associated with a given media asset. Remote server 415 may cross-reference the keywords with a keywords database 1000 (FIG. 10) to determine a type associated with the segment. Specifically, remote server 415 may cross-reference the keywords with database 1000 to determine whether the segment discussed in the messages includes a spoiler or material that exceeds a content rating assigned to the media asset.

In some embodiments, remote server 415 may determine that the keywords in the message indicate that the segment includes material that exceeds a content rating assigned to the media asset. In response, remote server 415 may retrieve a content rating assigned to the media asset and determine whether the content rating typically is associated with content that includes profanity or other vulgar language. If so, remote server 415 may disregard the messages and store as the information associated with the segment an indication that the segment does not include content that exceeds a content rating. As a result, a fast-access playback operation may be permitted through the segment of the media asset. In response to determining that the content rating typically is not associated with content that includes profanity or other vulgar language, remote server 415 may store as the information associated with the segment an indication that the segment includes content that exceeds a content rating and prevent a fast-access playback operation to be performed through the segment.

For example, the keywords included in database 1000 may include punctuation marks (e.g., exclamation point or question mark) that indicates a segment is of a spoiler type. The keywords included in database 1000 may include words that express excitement that indicate a segment is of a spoiler type. The keywords included in database 1000 may include actor or character names that indicate a segment is of a spoiler type. The keywords included in database 1000 may include profanity or vulgar words that indicate a segment includes material that exceeds a content rating assigned to the media asset. The keywords included in database 1000 may include words describing or associated with human body parts or private human body parts that indicate a segment includes material that exceeds a content rating assigned to the media asset.

In some embodiments, remote server 415 may parse each message posted to the social network and extract one or more words from each message. Remote server 415 may automatically generate an SQL query or instruction that includes the extracted words and transmit the query or instruction to database 1000. Database 1000 may execute the instructions of the query and identify types associated with the words in the query. Database 1000 may transmit information back to remote server 415 indicating the type(s) associated with the words in the query. Remote server 415 may store as the information that identifies a segment within a media asset the type returned by database 1000.

In some embodiments, control circuitry 304 may prevent a spoiler from being presented to a user on a website or other suitable content. For example, control circuitry 304 may receive a user request to access a website. In response, control circuitry 304 may parse contents of the website to determine whether spoilers are included in the website. Specifically, control circuitry 304 may analyze the contents of the website to determine whether any sporting event scores are included or whether any words or phrases, such as those found in database 1000 are on the website. Control circuitry 304 may parse the contents of the website and cross-reference the contents with database 1000 to identify a media asset and segment being discussed on the website. In response to determining that the website includes a spoiler, control circuitry 304 may identify the media asset associated with the spoiler on the website and retrieve a viewing history of the user to determine whether the user has previously seen the media asset for which the spoiler is displayed. When the user is determined to have not previously seen the media asset or spoiler being discussed on the website, control circuitry 304 may block access to the website or black out from display a region of the website that includes the spoiler. Control circuitry 304 may display an alert for the user indicating that the requested website was blocked because of a spoiler being detected. The user may instruct control circuitry 304 to display the website after being alerted. This prevents the user from being exposed to the spoiler on a website. Control circuitry 304 may process any content that the user requests access to in a similar manner as a website to prevent the user from being exposed to a spoiler.

In some embodiments, control circuitry 304 may prevent a spoiler from being presented to a user on a website or other suitable content by analyzing tags associated with the website or content. For example, control circuitry 304 may receive a user request to access a website. In response, control circuitry 304 may parse contents of the website to determine whether spoilers are included in the website. Specifically, control circuitry 304 may analyze the contents of the website to determine semantic web constructs, such as microformats, are associated with the website that indicate a spoiler is associated with the website. The semantic web constructs may uniquely identify a media asset and segments within the media asset that include a spoiler. In response to determining that the website is associated with such semantic web constructs, control circuitry 304 may determine when a viewing history of the user to indicates that the user has seen the spoiler or media asset associated with the semantic web construct. When the user is determined to have not previously seen the media asset or spoiler associated with the semantic web constructs, control circuitry 304 may block access to the website or black out from display a region of the website that includes the spoiler. Control circuitry 304 may display an alert for the user indicating that the requested website was blocked because of a spoiler being detected. The user may instruct control circuitry 304 to display the website after being alerted.

In some embodiments, control circuitry 304 may prevent a spoiler from being presented to a user on a social network feed. For example, control circuitry 304 may receive a social network feed (e.g., status updates received from a social network or posted to the social network). In response, control circuitry 304 may parse contents of the social network feed to determine whether spoilers are included in the social network feed. Specifically, control circuitry 304 may analyze the contents of the social network feed to determine whether any sporting event scores are included or whether any words or phrases, such as those found in database 1000 are in the social network feed. Control circuitry 304 may parse the contents of the social network feed and cross-reference the contents with database 1000 to identify a media asset and segment being discussed on the social network feed. In response to determining that the social network feed includes a spoiler, control circuitry 304 may identify the media asset associated with the spoiler in the social network feed and retrieve a viewing history of the user to determine whether the user has previously seen the media asset for which the spoiler is discussed. When the user is determined to have not previously seen the media asset or spoiler being discussed in the social network feed, control circuitry 304 may block access to the social network feed until the user is determined to have seen the media asset or spoiler. Control circuitry 304 may display an alert for the user indicating that a social network feed was blocked because of a spoiler being detected. The user may instruct control circuitry 304 to display the social network feed after being alerted. This prevents the user from being exposed to the spoiler in a social network feed.

In some embodiments, control circuitry 304 may prevent a spoiler from being presented to a user in an email message. For example, control circuitry 304 may receive an email message and in response, control circuitry 304 may parse contents of the email message to determine whether spoilers are included in the email message. Specifically, control circuitry 304 may analyze the contents of the email message to determine whether any sporting event scores are included or whether any words or phrases, such as those found in database 1000 are in the social network feed. Control circuitry 304 may parse the contents of the email message and cross-reference the contents with database 1000 to identify a media asset and segment being discussed on the email message. In response to determining that the email message includes a spoiler, control circuitry 304 may identify the media asset associated with the spoiler in the social network feed and retrieve a viewing history of the user to determine whether the user has previously seen the media asset for which the spoiler is discussed. When the user is determined to have not previously seen the media asset or spoiler being discussed in the social network feed, control circuitry 304 may block access to the email message until the user is determined to have seen the media asset or spoiler. Control circuitry 304 may display an alert for the user indicating that an email message was blocked because of a spoiler being detected. The user may instruct control circuitry 304 to display the email message after being alerted. This prevents the user from being exposed to the spoiler in an email message. Control circuitry 304 may store the email message in storage 308 and in response to determining the user has seen the media asset or spoiler, control circuitry 304 may automatically retrieve the email message and display the email message for the user.

In some embodiments, control circuitry 304 may prevent a spoiler from being presented to a user in an audio portion of a media asset. For example, control circuitry 304 may determine whether a segment of a media asset being viewed by a user includes a spoiler. Control circuitry 304 may perform such a determination based on information received from a crowd of users, information received from a remote server or any other suitable technique discussed above and below. Control circuitry 304 may monitor a position within the media asset being played back and determine based on the received information whether the position is near a segment that includes a spoiler. In response to determining that the segment of the media asset includes a spoiler, control circuitry 304 may retrieve a viewing history of the user to determine whether the user has previously seen the media asset for which the spoiler is discussed. When the user is determined to have not previously seen the media asset or spoiler being discussed in the media asset, control circuitry 304 may filter out only the audio portion of the media asset segment and so the video portion of the media asset segment continues to be displayed. This situation may arise in a multi-user context where each user in the group shares access to a display but has their own audio device (e.g., headphones) such as in a gym where multiple users watch the same screen and listen to the audio on their own devices. Each audio device may have a storage element that includes a viewing history for the user and is configured to block the audio portion of the media asset that includes the segment with the spoiler if the user has not seen the media asset segment previously. Accordingly, other users in the group that have seen the segment continue to receive both the audio and the video portions of the media asset segment with the spoiler while the user who has not seen the media asset segment receives only the video portion but not the audio portion of the media asset segment.

The functionality of processing the messages on the social network by remote server may be similarly performed by a given user equipment device 300. For brevity, the discussion is not being repeated but should be understood to be equally applicable. Specifically, a user equipment device 300 on which a user is requesting to perform a fast-access playback operation may generate information that identifies a segment that includes a spoiler or content that exceeds a rating of the media asset. User equipment device 300 may generate this information by accessing a social feed associated with a social network of the user and retrieve messages posted by friends of the user on the social network. User equipment device 300 may be equipped to process the received messages in a similar manner as remote server 415 to extract keywords or information from the messages to identify the media asset corresponding to the messages, a start/end position of the segment being discussed in the messages, and/or a type (e.g., spoiler or content that exceeds a rating of the media asset) of the segment.

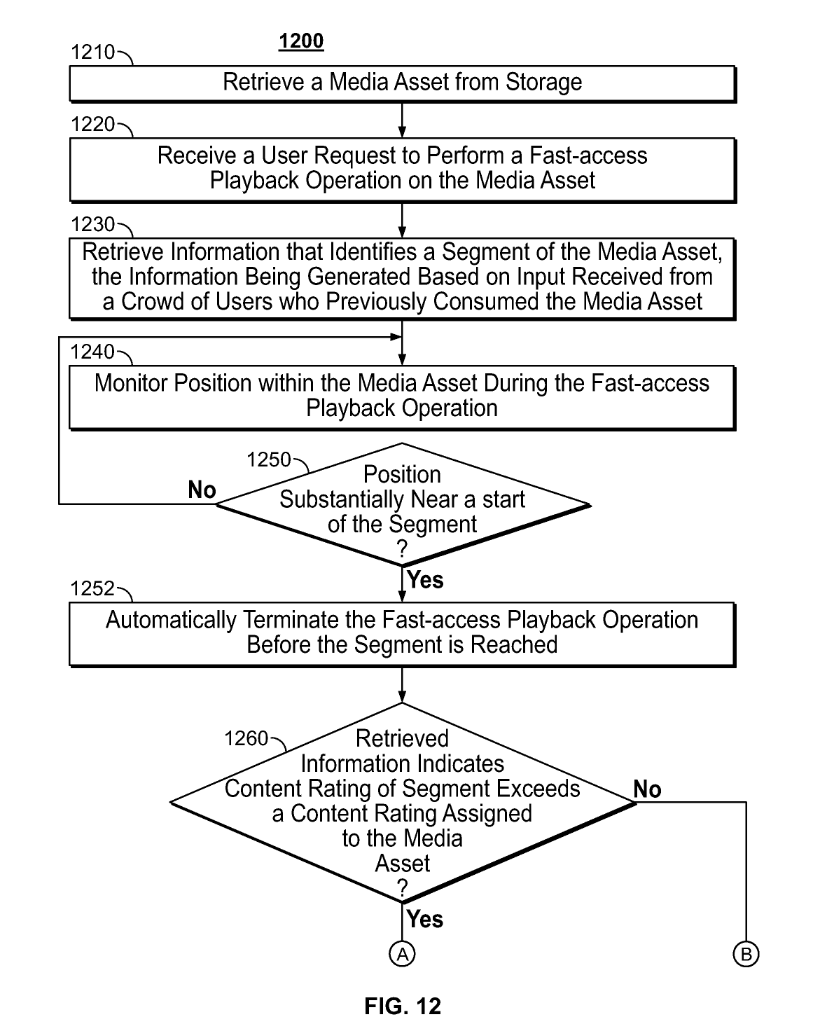

FIG. 11 is a diagram of a process 1100 for identifying media asset segments using a data feed that includes messages from users in a crowd in accordance with embodiments of the invention. Specifically, in some implementations, process 1200 of FIG. 11 may be a process that the media guidance application may instruct control circuitry 304 to perform. In some implementations, process 1100 of FIG. 11 may be a process or instructions stored in an instruction memory of processing circuitry on a remote server and which remote server 415 is configured to perform.

At step 1100, a data feed that includes messages from a crowd of users is accessed. For example, control circuitry 304 may transmit a query to a social network database or blog server requesting messages posted by users. The database may retrieve messages posted by users to the social network site and transmit the messages back to control circuitry 304 over a network (e.g., the Internet). In some implementations, control circuitry 304 may login to a social network site associated with the user and retrieve messages posted onto the social network site within a predefined or user specified time period.

At step 1120, the messages in the data feed are parsed to identify messages that correspond to a media asset and include keywords that identify an event within the media asset. For example, control circuitry 304 may process each word within each message and extract the word in the messages. Control circuitry 304 may generate an SQL query that includes the extracted words and transmit the SQL to a media asset database.

At step 1130, a timeframe during which the messages were posted is identified. For example, control circuitry 304 may determine based on information received from the social network database a time at which each message was posted to the social network or blog. Control circuitry 304 may add to the SQL query the time of each media asset to limit the range of media asset data the media asset database searches.

At step 1140, media asset schedule information corresponding to the timeframe is searched to identify the media asset that corresponds to the messages. The media asset database may execute instructions according to the SQL query to identify media asset data that includes the words in the SQL query and that are within the indicated timeframe (e.g., are scheduled for transmission during the indicated timeframe). The media asset database may transmit back to control circuitry 304 identifiers (e.g., titles) of any media asset that is associated with media asset data that includes the words in the SQL query.

At step 1150, a determination is made as to whether a media asset corresponding to the messages is found. In response to determining that a media asset is found, the process proceeds to step 1160, otherwise the process proceeds to step 1152.

At step 1152, the data feed is monitored for additional messages corresponding to a media asset. In response to determining that a predetermined number of additional messages have been received by the social network database, control circuitry 304 may repeat steps 1110, 1120, 1130 and 1150 using the information or words in the additional messages.

At step 1160, a determination is made as to whether keywords in the media asset are associated with obscene/offensive material. In response to determining that keywords in the media asset are associated with obscene/offensive material, the process proceeds to step 1162, otherwise the process proceeds to step 1180. For example, control circuitry 304 may process each word within each message and extract the word in the messages. Control circuitry 304 may generate an SQL query that includes the extracted words and specifies the type as being obscene/offensive material and transmit the SQL to keywords database 1000. Keywords database 1000 may search fields stored in database 1000 according to instructions in the SQL query whether any of the fields includes words in the SQL query and are associated with being of a type that is obscene/offensive (e.g., are indicated to be ‘R’ rated content). Database 1000 may transmit back a communication to control circuitry 304 indicating which words in the SQL query matched words in database 1000 that are identified as obscene/offensive. Database 1000 may also indicate in the communication a rating associated with each word found to be obscene/offensive.

At step 1162, a content rating assigned to the media asset is identified. For example, control circuitry 304 may cross-reference the identifier of the media asset (e.g., a title of the media asset) with a media asset database to determine what rating is assigned to the media asset.

At step 1170, a determination is made as to whether a content rating of the keyword exceeds a content rating of the media asset. In response to determining that the content rating of the keyword exceeds a content rating of the media asset, the process proceeds to step 1172, otherwise the process proceeds to step 1152.

At step 1172, information identifying a segment of the media asset corresponding to the timeframe as exceeding a content rating of the media asset is stored. For example, control circuitry 304 may update a media asset database to indicate a playback position (e.g., start/end times) of the segment within the media asset and include an indication that the segment includes material that has a content rating that exceeds a content rating assigned to the media asset.

At step 1180, a determination is made as to whether keywords in the media asset are associated with a positive/negative reaction. In response to determining that keywords in the media asset are associated with a positive/negative reaction, the process proceeds to step 1190, otherwise the process proceeds to step 1152. For example, control circuitry 304 may process each word within each message and extract the word in the messages. Control circuitry 304 may generate an SQL query that includes the extracted words and specifies the type as being associated with a positive/negative reaction and transmit the SQL to keywords database 1000. Keywords database 1000 may search fields stored in database 1000 according to instructions in the SQL query whether any of the fields includes words in the SQL query and are associated with a positive/negative reaction (e.g., have an exclamation mark or specify names of actors or characters). Database 1000 may transmit back a communication to control circuitry 304 indicating which words in the SQL query matched words in database 1000 that are identified as being associated with a positive/negative reaction. Database 1000 may also indicate in the communication whether the words are typically associated with a spoiler.

At step 1190, information identifying a segment of the media asset corresponding to the timeframe as including a spoiler that reveals an outcome to a previous plot portion of the media asset is stored. For example, control circuitry 304 may update a media asset database to indicate a playback position (e.g., start/end times) of the segment within the media asset and include an indication that the segment includes a spoiler.

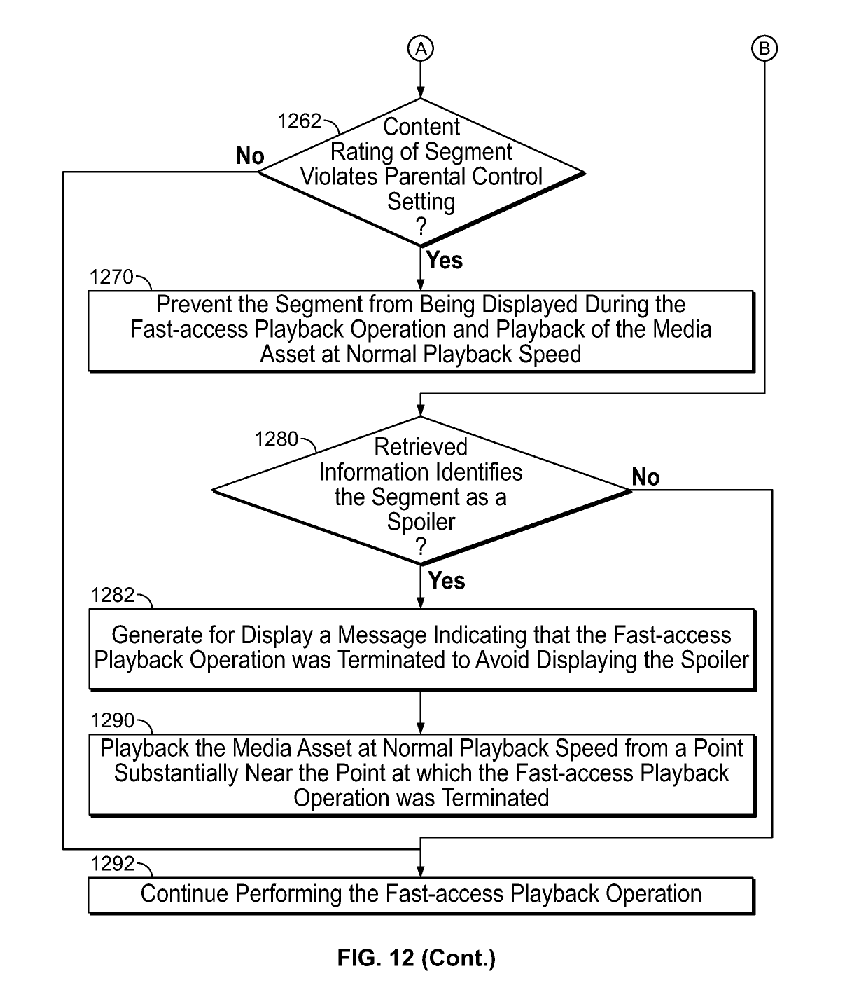

FIG. 12 is a diagram of a process 1200 for preventing access to a media asset segment during a fast-access playback operation in accordance with embodiments of the invention. Specifically, in some implementations, process 1200 of FIG. 12 may be a process that the media guidance application may instruct control circuitry 304 to perform. In some implementations, process 1200 of FIG. 12 may be a process or instructions stored in an instruction memory of processing circuitry on a remote server and which remote server 415 is configured to perform.

At step 1210, a media asset is retrieved from storage. For example, control circuitry 304 may receive a user selection of a program listing or media asset listing corresponding to a non-linear program or media. Control circuitry 304 may retrieve data associated with the selected listing to identify the storage location of the media or program. Specifically, in case the media asset is locally recorded content, the data may include a pointer to a storage location on a local storage device that identifies the starting address of the media asset stored. In case the media asset is an on-demand media asset provided by a remote server, the data may include a network address (e.g., IP address) that identifies the storage location on a remote server and the specific file that includes the content of the media asset. Remote server 415 may stream or transmit the media asset back to control circuitry 304 over the network.

At step 1220, a user request to perform a fast-access playback operation on the media asset is received. For example, control circuitry 304 may receive a user input from input interface 310 requesting that the fast-access playback operation be performed (e.g., a fast-forward or rewind operation). In response, control circuitry 304 may read and display contents of the media asset at an accelerated rate corresponding to the fast-access playback operation.

At step 1230, information that identifies a segment of the media asset is retrieved, the information being generated based on input received from a crowd of users who previously consumed the media asset. For example, the information may be generated using all or some of process 1100 (FIG. 11). For example, control circuitry 304 may transmit a request to a remote server for information associated with the media asset being played back. The information may include data that identifies start/end positions of one or more segments and types of those segments within the media asset. In some implementations, control circuitry 304 may locally generate the information based on a data feed received from a remote server.

At step 1240, a current position within the media asset is monitored during the fast-access playback operation. For example, control circuitry 304 may read the current position from a playback buffer corresponding to the current content being played back or presented in the fast-access playback operation. In some implementations, control circuitry 304 may retrieve the data from the same source as the data used to generate a transport bar which indicates the current playback position. The current position continuously changes at a rate faster than normal playback speed while the fast-access playback operation is being performed.

At step 1250, a determination is made as to whether the current position is substantially near a start of the segment. In response to determining that the current position is substantially near a start of the segment, the process proceeds to step 1252, otherwise the process proceeds to step 1240. For example, control circuitry 304 may determine whether the current position is within a predetermined amount of time (e.g., 5 seconds) of the start/end position of the segment identified in the information. Specifically, in case the fast-access playback operation is a request to reach a later point in time in the media asset playback faster (fast-forward operation), control circuitry 304 may compare the current position in the fast-access playback operation to a point that precedes the starting position of the segment by the predetermined amount of time. Similarly, in case the fast-access playback operation is a request to reach an earlier point in time in the media asset playback faster (rewind operation), control circuitry 304 may compare the current position in the fast-access playback operation to point that follows an ending position of the segment by the predetermined amount of time.

At step 1252, the fast-access playback operation is automatically terminated before the segment is reached. For example, control circuitry 304 may stop the fast-access playback operation and resume playing back the media asset at normal playback speed. Alternatively, control circuitry 304 may continue the fast-access playback operation but black out the displayed contents of the segment or block the audio of the segment identified by the information while the current playback position is between the start and end positions of the segment. Alternatively, control circuitry 304 may stop the fast-access playback operation and request instructions from the user for how to proceed and generate for display a notification explaining the reason for automatically terminating the fast-access playback operation.

At step 1260, a determination is made as to whether the retrieved information indicates a content rating of the segment exceeds a content rating assigned to the media asset. In response to determining that the retrieved information indicates a content rating of the segment exceeds a content rating assigned to the media asset, the process proceeds to step 1262, otherwise the process proceeds to step 1280.

At step 1262, a determination is made as to whether the content rating of the segment violates a parental control setting. In response to determining that the content rating of the segment violates a parental control setting, the process proceeds to step 1270, otherwise the process proceeds to step 1292. For example, the parental control setting may indicate that content that is associated with a content rating greater than PG should not be displayed without a PIN code. In response, control circuitry 304 may determine whether the content rating of the segment is greater than PG and thereby violates the parental control setting.

At step 1270, the segment is prevented from being displayed during the fast-access playback operation and playback of the media asset at normal playback speed. For example, control circuitry 304 may stop the fast-access playback operation and skip the segment to resume playing back the media asset at normal playback speed at a point following the end of the segment. Alternatively, control circuitry 304 may continue the fast-access playback operation but black out the displayed contents of the segment or block the audio of the segment identified by the information while the current playback position is between the start and end positions of the segment. Alternatively, control circuitry 304 may stop the fast-access playback operation and request instructions from the user for how to proceed and generate for display a notification explaining the reason for automatically terminating the fast-access playback operation.

At step 1280, a determination is made as to whether the retrieved information identifies the segment as a spoiler. In response to determining that the retrieved information identifies the segment as a spoiler, the process proceeds to step 1282, otherwise the process proceeds to step 1292.

At step 1282, a message indicating that the fast-access playback operation was terminated to avoid displaying the spoiler is generated for display. For example, control circuitry 304 may display message 720 (FIG. 7) indicating that the fast-access playback operation was terminated because a spoiler segment was detected.

At step 1290, the media asset is played back at normal playback speed from a point substantially near the point at which the fast-access playback operation was terminated. For example, control circuitry 304 may stop the fast-access playback operation and resume playing back the media asset at normal playback speed from a playback position that precedes a start time of the segment by five seconds when the fast-access playback operation is a fast-forward or skip forward operation. Control circuitry 304 may stop the fast-access playback operation and resume playing back the media asset at normal playback speed from a playback position that follows an end time of the segment by five seconds when the fast-access playback operation is a rewind or skip back operation.

At step 1292, the fast-access playback operation is continued to be performed.

It should be understood, that the above steps of the flow diagrams of FIGS. 11-12 may be executed or performed in any order or sequence not limited to the order and sequence shown and described in the figures. Also, some of the above steps of the flow diagrams of FIGS. 11-12 may be executed or performed substantially simultaneously where appropriate or in parallel to reduce latency and processing times.

The above described embodiments of the present disclosure are presented for purposes of illustration and not of limitation, and the present disclosure is limited only by the claims which follow.

1. A method for preventing access to a segment of a media asset during a fast-access playback operation, the method comprising:
retrieving the media asset from storage;
receiving, during a first segment of the media asset, a user request to perform a fast-access playback operation on the media asset;
retrieving, while performing the fast-action playback operation through the first segment, information that identifies a second segment of the media asset, wherein the information is generated based on input received from a plurality of users that have previously consumed the media asset; and
automatically terminating the fast-access playback operation before the second segment is reached based on the retrieved information.

2. The method of claim 1 further comprising:
determining whether the second segment is about to be reached during the fast-access playback operation based on the retrieved information;
wherein the automatically terminating is performed in response to determining the second segment is about to be reached.

3. The method of claim 1, wherein the fast-access playback operation is one of a rewind operation, a fast forward operation, a skip operation, a non-sequential playback operation, and a next or previous chapter operation.

4. The method of claim 1, wherein the information is generated by:
monitoring a social network to identify messages from the plurality of users posted to the social network that are associated with the media asset; and
identifying a starting point of the second segment based on when the messages were posted to the social network.

5. The method of claim 1, wherein the plurality of users has previously consumed the media asset by viewing a first time transmission of the media asset or a previously stored version of the media asset before the user.

6. The method of claim 1, wherein the media asset includes a plot, and wherein the second segment includes a spoiler that reveals an outcome to a previous portion of the plot.

7. The method of claim 1, wherein:
the media asset includes a sequence of consecutive plot portions and an advertisement portion;
the second segment corresponds to a first of the consecutive plot portions that follows a second of the consecutive plot portions in the sequence; and
automatically terminating the fast-access playback operation terminating comprises automatically terminating the fast-access playback operation after the advertisement portion and the second of the consecutive plot portions and before the first of the consecutive plot portions.

8. The method of claim 1 further comprising:
retrieving a parental control setting associated with the user, wherein media asset information associated with the media asset indicates that access to the media asset does not violate the parental control setting; and
determining whether the second segment includes content that violates the parental control setting;
wherein the automatically terminating is performed in response to determining the second segment includes content that violates the parental control setting.

9. The method of claim 1, wherein the automatically terminating includes at least one of skipping the second segment, accessing the media asset at normal playback speed from a portion preceding the second segment, preventing display of a portion of video of the second segment, preventing playback of audio of the second segment, alerting the user about the second segment, and stopping the fast-access operation.

10. The method of claim 1 further comprising:
receiving input identifying at least one of a starting point and an ending point of the second segment from the plurality of users; and
storing the at least one of the starting point and the ending point as the generated information.

11. A system for preventing access to a segment of a media asset during a fast-access playback operation, the system comprising:
a storage device; and
control circuitry configured to:
retrieve the media asset from the storage device;
receive, during a first segment of the media asset, a user request to perform a fast-access playback operation on the media asset;
retrieve, while performing the fast-action playback operation through the first segment, information that identifies a second segment of the media asset, wherein the information is generated based on input received from a plurality of users that have previously consumed the media asset; and
automatically terminate the fast-access playback operation before the second segment is reached based on the retrieved information.

12. The system of claim 11, wherein the control circuitry is further configured to:
determine whether the second segment is about to be reached during the fast-access playback operation based on the retrieved information; and
automatically terminate the fast-access playback operation response to determining the second segment is about to be reached.

13. The system of claim 11, wherein the fast-access playback operation is one of a rewind operation, a fast forward operation, a skip operation, a non-sequential playback operation, and a next or previous chapter operation.

14. The system of claim 11, wherein the information is generated by:
monitoring a social network to identify messages from the plurality of users posted to the social network that are associated with the media asset; and
identifying a starting point of the second segment based on when the messages were posted to the social network.

15. The system of claim 11, wherein the plurality of users has previously consumed the media asset by viewing a first time transmission of the media asset or a previously stored version of the media asset before the user.

16. The system of claim 11, wherein the media asset includes a plot, and wherein the second segment includes a spoiler that reveals an outcome to a previous portion of the plot.

17. The system of claim 11, wherein:
the media asset includes a sequence of consecutive plot portions and an advertisement portion;
the second segment corresponds to a first of the consecutive plot portions that follows a second of the consecutive plot portions in the sequence; and
the control circuitry is further configured to automatically terminate after the advertisement portion and the second of the consecutive plot portions and before the first of the consecutive plot portions.

18. The system of claim 11, wherein the control circuitry is further configured to:
retrieve a parental control setting associated with the user, wherein media asset information associated with the media asset indicates that access to the media asset does not violate the parental control setting; and
determine whether the second segment includes content that violates the parental control setting;
automatically terminate the fast-access playback operation in response to determining the second segment includes content that violates the parental control setting.

19. The system of claim 11, wherein the control circuitry is further configured to automatically terminate by at least one of skipping the second segment, accessing the media asset at normal playback speed from a portion preceding the second segment, preventing display of a portion of video of the second segment, preventing playback of audio of the second segment, alerting the user about the second segment, and stopping the fast-access operation.

20. The system of claim 11, wherein the control circuitry is further configured to:
receive input identifying at least one of a starting point and an ending point of the second segment from the plurality of users; and
store the at least one of the starting point and the ending point as the generated information.

21-30. (canceled)
